(19) United States
(12) Patent Application Publication
(10) Pub. No.: US 2019/0193273 A1
(43) Pub. Date: Jun. 27, 2019

(54) ROBOTS FOR INTERACTIVE COMEDY AND COMPANIONSHIP

(71) Applicant: TAECHYON ROBOTICS CORPORATION, SACRAMENTO, CA (US)

(72) Inventors: Stephen James FAVIS, SACRAMENTO, CA (US); Deepak SRIVASTAVA, SAN JOSE, CA (US)

(73) Assignee: TAECHYON ROBOTICS CORPORATION

(21) Appl. No.: 16/289,569

(22) Filed: Feb. 28, 2019

Related U.S. Application Data
(63) Continuation of application No. PCT/US2017/049458, filed on Aug. 30, 2017.
(60) Provisional application No. 62/381,976, filed on Aug. 31, 2016.

(51) Int. Cl. B25J 11/00; G06F 16/2458; G06F 16/23; G06N 3/00; B25J 9/16

(52) U.S. Cl. CPC B25J 11/0015; G06F 16/2465; G06F 16/2379; G06N 20/00; B25J 11/003; B25J 9/163; G06F 2216/03; G06N 3/008

(57) ABSTRACT

Method, systems, and algorithms are provided to generate and deliver interactive jokes, comedy monologues, comedy dialogues and comedy routines i) to a user/group in-person, via an interactive comedic robot or ii) to the user/group remotely, via an animated robot, chat-bot, or chatter-bot on internet connected television-, or web-, or mobile-, or projector-interface. Methods include creating a database of topics, set-up comments, punch lines and audio- and video-recordings of canned laughter and emotions. Algorithms include the selection and delivery of the topics, the set-up comments, and the punch lines packaged with the canned laughter and emotions. The jokes/comedy are delivered in a synthesized/recorded robotic or human voice representing one or more than one personality of the robot. The disclosed robots are usable for interactive entertainment, companionship, education, training, greeting, guiding and customer service applications as well as for user feed-back, customization, and crowdsourcing.

### CROSS-REFERENCE TO RELATED APPLICATION

This application is continuation of International Patent Application No. PCT/US2017/049458, which claims benefit of U.S. Provisional Patent Application No. 62/381,976, filed Aug. 31, 2016. The content of the aforementioned applications, including any intervening amendments thereto, are incorporated herein by reference.

### BACKGROUND

### 1. Technical Field

The present disclosure relates generally to the field of robots. The present disclosure relates specifically to robots that interact with human users on a regular basis, called social robots. The present disclosure also includes software based personalities of robots capable of interacting with a user, through internet or mobile connected web- or mobile devices, called chat-bots or chatter-bots.

### 2. Background of the Disclosure

Traditionally, robots have been developed and deployed for last few decades in a variety of industrial production, packaging, shipping and delivery, defense, healthcare, and agriculture areas with a focus on replacing many of the repetitive tasks and communications in pre-determined scenarios. The robotic systems perform the same tasks with a degree of automation. With advances in artificial intelligence and machine learning capabilities in recent years, robots have started to move out of commercial, industrial and lab-level pre-determined scenarios to the interaction, communication, and even co-working with human users in a variety of application areas.

Social robots are being proposed and developed for robot systems and their purely software counterparts, including robotic chat- or chatter-bots, to interact and communicate with human users in a variety of application areas such as child and elderly care, receptionist, greeter, and guide applications, and multiple-capability home assistant, etc. Their software based counter parts are created to perform written (chat) or spoken verbal (chatter) communication with human users called—chat-bots or chatter-bots, respectively. These are traditionally based on a multitude of software such as Eliza in the beginning and A.L.I.C.E (based of AIML—Artificial Intelligent Markup Language) recently, which is available on open-source. In addition to advanced communication capabilities with human users, social robots also possess a whole suite of on-board sensors, actuators, controllers, storage, logic and processing capabilities needed to perform many of the typical robot like mechanical, search, analysis, and response functionalities during interactions with a human user or group of users.

The personality of a robot interacting with a human user with typical robot like characteristics and functions has become important as robotic applications have moved increasingly closer to human users on a regular basis. The personality of a robot is referred to as the knowledge database accessible and a set of rules through which a robot chooses to respond, communicate, and interact with a user or a group of users. Watson, Siri, Pepper, Buddy, Jibo, and Echo are few prominent examples of such human interfacing social chat-bots, chatter-bots and robots which respond in typical robot-like personality traits. The term multiple personalities in robots have been referred to for a central computer based robot management system in a client-server model to manage characteristics or personalities of many chat-bots or robots at the same time. Architecturally, this makes it easier to upload, distribute, or manage personalities in many robots at the same time and communications between many robots are also possible. Furthermore, recently along similar lines, a remote cloud-based architectural management system has also been proposed where many personality types of a robotic system could be developed, modified, updated, uploaded, downloaded, or stored efficiently using cloud computing capabilities. The sense of more than one personality type in a robot based on stored data and set of rules can be chosen by the robot or by a user depending upon the circumstances related to a user or representing mood of the user. The idea of a cloud computing based architecture or capabilities is to make it facile to store, distribute, modify, and manage such multiple personalities.

Related International Patent Application No. PCT/US17/29385 describes robots or robotic systems capable of exhibiting Multiple Interacting Personalities (MIP) and their software version as Animated Multiple Interacting Personalities (AMIP) chat- and chatter-bots which could include both robot-like personality traits expressed in one voice and “inner human-like” personality traits in another voice with accompanying suitable facial expressions capable of switching back and forth during a continuing interaction or communication with a user.

A key part of single or multiple interactive personality robots, chat-bots or chatter-bots designed for entertainment is the ability to create interactive jokes, or comedic monologues or dialogues with a user or a group of users face-to-face or remotely via the animated versions on the web- or mobile-interfaces. Methods, algorithms, and systems are provided to generate and deliver interactive jokes, and comedy monologue, dialogues and routines via in-person face-to-face robotic systems and devices, or remotely via animated robots, chat-bots, or chatter-bots on the internet connected television-, projector-, web- and mobile-interfaces for a user or a group of users are described in this disclosure.

### SUMMARY

The object of the present disclosure is to provide a method, algorithm and system to generate and deliver interactive jokes, and comedy monologues and dialogues routines via in-person face-to-face robotic systems and devices, or remotely via animated robots, chat-bots, or chatter-bots on web-, mobile-, television-, and projector-interfaces.

According to one aspect of the present disclosure, without any limitation, the algorithm, method, and system for jokes and comedy routines includes creation, storage, deletion, modification, and update of data into a database including one or more than one topic, one or more than one set-up comment relevant to each topic, one or more than one punch line relevant to each topic, audio and video recordings of canned laughter of variable duration and intensity, audio and video recordings of canned or synthesized sounds for empathy, encouragement, applause, and other emotions. According to another aspect, without any limitation, the created data, databases, data storage, deletion, modification, update, retrieval, and delivery methods could be of the legacy SQL based relational database management system types, or the newer NoSQL database types, or any of the hybrid types combining the advantages of the two.

According to another aspect of the present disclosure, without any limitation, the input data of topics, set-up comments relevant to each topic, and punch lines relevant to each topic and their set-up comments form a database block called a core content (CC) database, and the input data of canned audio and video recordings of laughter and emotions such as empathy, encouragement, happiness, and applause form a database block called a content packaging (CP) database. According to yet another aspect of the present disclosure, the overall input database for generating interactive jokes, comedy monologues, comedy dialogues, and comedy routines includes both the CC and CP databases types.

According to one aspect of the present disclosure, without any limitation, a first source of the input data of topics, set-up comments relevant to topics, and punch lines relevant to topics and their set-up comments is generated by and from face-to-face or remote users interacting with the robot or web- or mobile-based interfaces designed to obtain such data using crowd-souring methodologies to populate the databases with user generated data. According to another aspect of the present disclosure, without any limitation, another or a second source of the input data of topics, set-up comments relevant to topics, and punch lines relevant to topics and their set-up comments is harvested from existing audio and video recordings of stand-up, improv, and dramatic comedians performing jokes, comedy monologues, comedy dialogues, and comedy routines in radio or television sitcoms using data-mining and learning algorithms implemented as a software on a computer hardware system or on a backend cloud computing system. According to yet another aspect of the present disclosure, without any limitation, a third source of the input data of topics, set-up comments relevant to topics, and punch lines relevant to topics and their set-up comments to populate the databases is a mixture or hybrid of (i) the first source of user generated data using crowdsourcing methodologies and (ii) the second source of data harvested from existing audio and video recordings using data-mining and learning algorithms implemented as a software on a computer hardware system or on a backend cloud computing system.

According to one aspect of the present disclosure, an example algorithm, without any limitation, selects topics, selects set-up comments relevant to the selected topic, and selects punch lines relevant to the selected topic and their selected set-up comments from user-generated, data-mined, and hybrid sourced data from the CC database to create and store the content of new jokes, new comedy monologues, new comedy dialogues, and new comedy routines in the CC database as according to a need or as according to a user preferences under the chosen or selected topic for use by a single- or multiple-personality robot or animated single- or multiple personality chat- or chatter-bots interacting with a user or group of users.

According to another aspect of the present disclosure, an example algorithm, without any limitation, based on the context of a continuing interaction or communication of a robot with a user or a group of users, selects a topic of a joke or comedy routine, selects and delivers a first set-up comments relevant to the topic chosen from the CC database, selects and delivers a second set-up comment relevant to the topic chosen from the CC database. According to yet another aspect of the present disclosure, after the first and second set-up comments have been delivered, the algorithm, without any limitation, also selects and delivers a punch line from the CC database relevant to the topic chosen followed by the selection and delivery of a canned audio-video-laughter of variable duration and intensity from the CP database during a continuing interaction between a robot and user or a group of users. According to yet another aspect of the present disclosure, the algorithm, without any limitation, is allowed to select and deliver two or more than two set-up comments and one or more than one punch lines after each set of two or more than two set-up comments from the CC database, and follow each punch line with the selection and delivery of canned audio and/or video laughter and emotion sequences to a user or group of users during a continuing interaction between the robot and user or a group or users.

According to one aspect of the present disclosure, without any limitation, the above data, databases, and storage, retrieval, and delivery algorithms, software, and method could be part of a robotic system or a device facing and interacting with a user, or could be part of a mobile system or device within an interaction region of a robotic system or device facing or interacting with a user, or could be part of a cloud based system or device located remotely and used for storage, retrieval, and delivered to a robotic system or device facing or interacting with a user, or could be part of web-based system or device used for storage, retrieval, and delivered to a robotic system or device facing or interacting with a user.

According to one aspect of the present disclosure, without any limitation, the robot-user interactive jokes and comedy routines are delivered in synthesized or recorded robotic or human voices representing one or more than one multiple interactive personalities (MIP) of a robot or animated multiple interactive personalities (AMIP) chatter- or chat-bots, as disclosed in related International Patent Application No. PCT/US17/29385, delivered to a user or a group of users interacting with a robotic system with only one robot- or human-like personality or with MIP or AMIP type robots and chatter-bots, respectively, with one or more than one interactive personalities, as disclosed in related International Patent Application No. PCT/US17/29385.

According to one aspect of the present disclosure, without any limitation, the AMIP chat- and chatter-bots using web- and mobile-interfaces are used for creation, storage, and delivery of on-line interactive jokes and comedy routines to a remote user or a group of remote users on any web or mobile connected remote device or devices. The internet connected remote devices, without any limitations, could be desk-top, lap-top, note-book, chrome-book type computers, smart-phones or -pad type mobile hand-held devices, or regular or smart televisions or projectors connected to internet.

According to one aspect of the present disclosure, AMIP chat and chatter-bots on web- and mobile interfaces on internet or mobile connected devices, without any limitation, are used for crowdsourcing of input-data on topics, set-up comments and punch lines relevant to the topics from individual users or group of users. The topics, set-up comments, and punch lines relevant to topics are analyzed, modified, and accepted by human professional comedians or machine learning based AI computer programs for inclusion, update, and growth of topics, set-up comments and punch line databases included and used in the algorithm.

According to another aspect of the present disclosure, the AMIP chat and chatter-bots on web- and mobile interfaces on internet or mobile connected devices for a remote user or a group of remote users, and the MIP robots during face to face interaction with a user or a group of users, without any limitation, are used for receiving, monitoring, and analyzing user responses, laughter, and any other input in a feed-back algorithm for optimization and customization of jokes, comedy monologues, dialogues, and routines as according to user preferences. The user preferred customized jokes, and comedy monologues, dialogues, or routines created using AMIP chat- and chatter-bots are then also available for down-load into a MIP robot or robotic system for use during MIP robot-user interactions.

In one aspect, the method also provides for example algorithms to include the jokes, and comedy monologues, dialogues, or routines with/during a regular continuing interaction or communication of a MIP robot, or an AMIP chat- or chatter-bot with a user or a group of users. The example algorithms, as disclosed in related International Patent Application No. PCT/US17/29385, without any limitation, include user-robot interactions with: (a) no overlap or conflict in the responses and switching of multiple interactive personalities during a dialog, (b) customization of multiple interactive personalities according to a user's preferences using crowd sourcing environment, and (c) customization of the ratio of robot-like and human-like personality traits within MIP robots or within AMIP chat- or chatter bots as according to a user preferences.

The above summary is illustrative only and is not intended to be limiting in any way. The details of the one or more implementations of this disclosure are set forth in the accompanying drawings and detailed description below. Other features, objects, and advantages of the disclosure will be apparent from the description and drawings, and from the claims.

### BRIEF DESCRIPTION OF FIGURES

FIG. 1 An example schematic of a MIP robot with main components.

FIG. 2A An example schematic of a MIP robot interacting with a user, wherein the user is standing.

FIG. 2B An example schematic of a MIP robot interacting with a group of users, wherein a user is sitting and another user is standing.

FIG. 3 An example block diagram of the main components of an example database for creation, storage, and delivery of topics, set-up comments, punch lines, laughter, and enhancements for a robot interacting with a user.

FIG. 4A An example block diagram of the main components of an example core content database sourced from user generated content data.

FIG. 4B An example block diagram of the main components of an example core content database sourced from data-mined content data.

FIG. 5 An example algorithm to select topics, set-up comments and punch lines from the core content database, and packaged with audio- and video-recordings of laughter, musical enhancements, and audience emotional response from the content packaging database to generate and deliver a joke or a comedy routine to a user or a group of users.

FIG. 6 An example algorithm to select topics, set-up comments and punch lines relevant to a user's traits, geolocation, habits, personality, and other features to focus the created jokes and comedy routines as according to a user's preferences.

FIG. 7A An example schematic of an AMIP chat- or chatter bot interacting with a user through a web-interface.

FIG. 7B An example schematic of an AMIP chat- or chatter bot interacting with a user through mobile interfaces.

FIG. 8A An example schematic to establish a probabilistic weight for a user to choose whether a robot will respond with a comedic personality trait or a serious personality trait.

FIG. 8B An example algorithm for customizing a ratio of comedic content delivered and non-comedic content delivered to a user as according to user preferences.

FIG. 9 An example MIP robot with processing, storage, memory, sensor, controller, I/O, connectivity, and power units and ports within the robot system.

FIG. 10 An example interactive television system including an internally or externally connected robotic system or a device to a television for comedic AMIP chat and chatter-bots interacting with a user.

### DETAILED DESCRIPTION

Details of the present disclosure are described with illustrative examples to meet statutory requirements. However, the description itself and the illustrative examples in figures are not intended to limit the scope of this disclosure. The inventors have contemplated that the subject matter of the present disclosure might also be embodied, in other ways, to include different steps or different combination of steps similar to the ones described in this document, in conjunction with the present and future technological advances. Similar symbols used in different illustrative figures identify similar components unless contextually stated otherwise. The terms herein, “steps,” “block,” and “flow” are used below, to explain different elements of the method employed, and should not be interpreted as implying any particular order among different steps unless any specific order is explicitly described for the various aspects of this disclosure.

Aspects of the present disclosure are directed towards providing a method and system for a robot to generate and deliver interactive jokes, and comedy monologues and dialogues routines via in-person face-to-face robotic systems and devices, or remotely via animated robots, chat-bots, or chatter-bots on web- and mobile interfaces. The algorithm, method, and system for jokes and comedy routines includes creation, storage, and update of data into a database including a list of topics, one or more than one set-up comment relevant to each topic, and one or more than one punch line relevant to each topic, canned laughter of variable duration and intensity, videos or animation of robots and people laughing in different scenarios and different duration. According to another aspect, without any limitation, the created databases, data storage, update, retrieval, and delivery methods without any limitation could be of legacy SQL relational database types, or the newer NoSQL database types, or any of the hybrid types combining the advantages of the two.

Based on the aspects of the present disclosure, without any limitation, the input data to populate a database of topics, set-up comments relevant to topics, and punch lines relevant to topics and their set-up comments is obtained from two sources. One source of the input-data is directly obtained from remote users using web- and mobile-based interfaces designed to obtain such input data within a crowd-souring methodology to generate user or potential customer supplied data. Another source of the input data is harvested from existing audio and video recordings of comedians performing jokes, comedy monologues, comedy dialogues, and comedy routines in radio or television sitcoms using data-mining, artificial intelligence and machine learning algorithms implemented as software on a computer hardware system or a backend cloud computing system.

Based on the aspects of the present disclosure, without any limitation, an artificial intelligence or machine learning algorithm is implemented to select topics, set-up comments relevant to the topic, and punch lines relevant to the topic and their set-up comments from the two input-data sources to create and store new jokes, comedy monologues, comedy dialogues, and comedy routines as according to user preferences.

Based on various aspects, as disclosed in related International Patent Application No. PCT/US17/29385, a MIP robot or an AMIP chatter-bot on the web or mobile interface is able to express emotions, ask direct questions, tell jokes, perform comedy monologues, comedy dialogues, and comedy routines, make wise-cracking remarks, give applause, and give philosophical answers in a “human like” manner with a “human like” voice during a continuing interaction or communication with a user, while also interacting and speaking in a “robot like” manner and “robot like” voice during the same continuing interaction or communication with the same user without any overlap or conflict. Such MIP robots can be used as entertaining social or human companionship robots including, but not limited to, situational or stand-up comedy, karaoke, gaming, teaching and training, elderly companionship, greeting, guiding and customer service types of applications.

Based on the aspects of the present disclosure, without any limitation, the algorithm for jokes and comedy routines includes the selection and delivery of the topics stored within the robotic system based on an introductory or interactive current communication exchange between a robotic system and a user. Once the topic of an impending joke or a comedy routine is chosen, without any limitation, the algorithm includes the selection and delivery of the first set-up comment relevant to the topic chosen stored within the robotic system. Once the first set-up comment has been delivered, without any limitation, the algorithm includes the selection and delivery of a follow up second set-up comment relevant to the topic chosen stored within the robotic system.

Based on the aspects of the present disclosure, without any limitation, after the first and second set-up comments relevant to the chosen topic have been delivered, the algorithm includes, without any limitation, the selection and delivery of the first punch line relevant to the topic chosen stored within the robotic system based on an introductory or interactive previous communication exchange between a robotic system and a user, followed by the selection and delivery of a audio- or video recording of canned laughter of variable duration and intensity stored within the robotic system based on a previous introductory or interactive communication exchange between a robotic system and a user, accompanied with audio- or video recording of canned emotions such as laughter, empathy, applaud to finish the joke or a comedy routine.

Based on the aspects of the present disclosure, without any limitation, after the first punch line followed by the first canned laughter have been delivered, the algorithm includes the selection and delivery of the additional one or more than one punch lines followed by canned laughter of variable duration and intensity each time stored within the robotic system based on a previous introductory or interactive communication exchange between a robotic system and a user, accompanied with audio- or video recording of canned emotions such as laughter, empathy, applaud to finish the joke or a comedy routine.

Based on the aspects of the present disclosure, without any limitation, the data including topics, set-up comments, punch lines, canned laughter, video or animation footage of people and robots laughing and expressing other emotions, stored in the databases, and storage, reading, writing, deleting, updates, retrieval, and delivery algorithms, software, and methods could be part of a physical robotic system or a device facing and interacting with a user, or could be part of a mobile system or a device within an interaction region of a robotic system or device facing or interacting with a user, or could be part of a cloud based system or device located remotely and used for storage, retrieval, and delivered to a robotic system or device facing or interacting with a user, or could be part of web-based system or device used for storage, retrieval, and delivered to a robotic system or device facing or interacting with a user.

Based on the aspects of the present disclosure, without any limitation, the robot-user interactive jokes and comedy routines are delivered in synthesized or recorded robotic or human voices representing one or more than one multiple interactive personalities (MIP) of a robot or animated multiple interactive personalities (AMIP) chatter- or chat-bot, as disclosed in related International Patent Application No. PCT/US17/29385, delivered to a user or a group of users interacting with a robotic system with only one robot or human like personality or with MIP or AMIP type robots and chatter-bots, respectively, with one or more than one interactive personalities, as disclosed in related International Patent Application No. PCT/US17/29385.

According to one aspect of the present disclosure, without any limitation, the AMIP chat- and chatter-bots using web- and mobile-interfaces are used for creation, storage, and delivery of on-line interactive jokes and comedy routines to a remote user or a group of remote users on any web or mobile connected remote device or devices. The internet connected remote devices, without any limitations, could be desk-top, lap-top, note-book, chrome-book type computers, smart-phones or -pad type mobile hand-held devices, or regular or smart televisions, or augmented-reality (AR) and virtual-reality (VR) devices connected to internet.

According to one aspect of the present disclosure, AMIP chat and chatter-bots on web- and mobile interfaces on internet or mobile connected devices, without any limitation, are used for crowdsourcing of input-data on topics, set-up comments and punch lines relevant to the topics from individual users or group of users. The topics, set-up comments, and punch lines relevant to topics are analyzed, modified, and accepted by human professional comedians or machine learning based AI computer programs for inclusion, update, and growth of topics, set-up comments and punch line databases included and used in the algorithm.

According to another aspect of the present disclosure, the AMIP chat and chatter-bots on web- and mobile interfaces on internet or mobile connected devices for a remote user or a group of remote users, and the MIP robots during face to face interaction with a user or a group of users, without any limitation, are used for receiving, monitoring, and analyzing user responses, laughter, and any other input in a feed-back algorithm for optimization and customization of jokes, comedy monologues, dialogues, and routines as according to user preferences. The user preferred customized jokes, and comedy monologues, dialogues, or routines created using AMIP chat- and chatter-bots are then also available for down-load into a MIP robot or robotic system for use during MIP robot-user interactions.

In one aspect, the method also provides for example algorithms to include the jokes, and comedy monologues, dialogues, or routines with/during a regular continuing interaction or communication of a MIP robot, or an AMIP chat- or chatter-bot with a user or a group of users. The example algorithms, as disclosed in related International Patent Application No. PCT/US17/29385, without any limitation, include user-robot interactions with: (a) no overlap or conflict in the responses and switching of multiple interactive personalities during a dialog, (b) customization of multiple interactive personalities according to a user's preferences using a crowd sourcing environment, and (c) customization of the ratio of robot-like and human-like personality traits within MIP robots or within AMIP chat- or chatter bots as according to a user preferences.

In another aspect, the user preferred and customized AMIP chat- and chatter-bots using web- and mobile interfaces and MIP robots at a physical location are used for applications including, but not limited to, educational training and teaching, child care, elderly companionship, gaming, situational and standup comedy, karaoke singing, and other entertainment routines while still providing all the useful functionalities of a typical robot, or a social robot, or a human companionship robot at home.

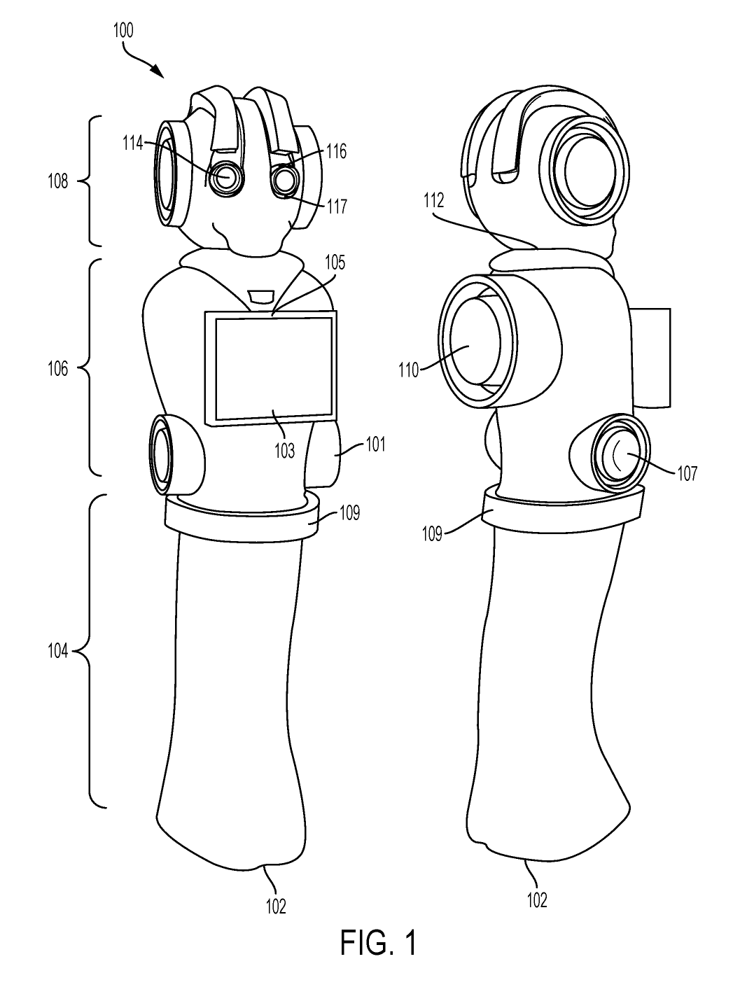

Having briefly described an example overview of the various aspects of the present disclosure, an example MIP robot system, and components in which aspects of the present disclosure may be implemented are described below in order to provide a general context of various aspects of the present disclosure. Referring now to FIG. 1, an example robot system, as detailed in related International Patent Application No. PCT/US17/29385, for implementing aspects of the present disclosure is shown and designated generally as a MIP robot device 100. It should be understood that the robot device 100 and other arrangements described herein are set forth only as examples and are not intended to be of suggest any limitation as to the scope of the use and functionality of the present disclosure. Other arrangements and elements (e.g. machines, interfaces, functions, orders, and groupings etc.) can be used instead of the ones shown, and same elements may be omitted altogether and some new elements may be added depending upon the current and future status of relevant technologies without altering the aspects of the present disclosure. Furthermore, the blocks, steps, processes, devices, and entities described in this disclosure may be implemented as discrete or distributed components or in conjunction with other components, and in any suitable combination and location. Various functions described herein as being performed by the blocks shown in figures may be carried out by hardware, firmware, and/or software.

A robotic device 100 in FIG. 1 includes, without any limitation, a base 104, a torso 106, and a head 108. The base 104 supports the robot and includes wheels for mobility which are inside of the base 110 (not shown). The base includes internal power supplies, charging mechanisms, and batteries (not shown). In one aspect, the base could itself be supported on another moving platform 102 with wheels for the robot to move around in an environment including a user or a group user configured to interact with the robot. The torso 106 includes a video camera 105, touch screen display 103, left 101 and right 107 speakers, a sub-woofer speaker 110 and I/O ports for connecting external devices 109. In one aspect, the display 103 is used to show the text form display of the “human like” voice to represent “human like” trait or personality spoken through speakers and a sound-wave form display of the synthesized robotic voice spoken through speakers to represent “robot like” personality of the robot. The head 108 includes a neck with 6 degrees of movement including pitch (rotate/look up and rotate/look down), yaw (rotate/look left and rotate/look right), and roll (rotate left and rotate right looking forward). In alternative aspects the degrees of movement include translations of the head 108 in relation to the torso 106 (e.g., translation/shift forward and translation/shift backward). Such degrees of movement are disclosed more fully in related International Patent Application No. PCT/US17/29385. Changing facial expressions are accomplished with eyes lit with RGB LED's 114, with opening and closing animatronic upper eyelids 116 and lower eyelids 117. In addition to the above list of general components and their functions, a typical robot also includes power unit, charging, computing or processing unit, storage unit, memory unit, connectivity devices and ports, and a variety of sensors and controllers. These structural and component building blocks of a MIP robot represent example logical, processing, sensor, display, detection, control, storage, memory, power, input/output and not necessarily actual, components of a MIP robot. For example a display device unit could be touch or touch less with or without mouse and keyboard, with USB, HDMI, and Ethernet cable ports could be representing the key I/O components, a processor unit could also have memory and storage as according to the art of technology. FIG. 1 is an illustrative example of a robot device that can be used with one or more aspects of the present disclosure.

Aspects of the present disclosure may be described in the general context of a robot with onboard sensors, speakers, computer, power unit, display, and a variety of I/O ports. Wherein the computer or computing unit includes, without any limitation, the computer codes or machine readable instructions, including computer readable program modules executable by a computer to process and interpret input data generated from a MIP robot configured to interact with a user or a group of user and generate output response through multiple interactive voices representing switchable multiple interactive personalities (MIP) including humanlike and robot like personality traits. Generally, program modules include routines, programs, objects, components, data structures etc., referring to computer codes that take input data, perform particular tasks, and produce appropriate response by the robot. Through the USB, Ethernet, WIFI, modem, HDMI ports the MIP robot is also connected to the internet and cloud computing environment capable of uploading and downloading of the personalities, questions, user response feed backs, and modified personalities from and to the remote source such as cloud computing and storage environment, a user or group of users configured to interact with the MIP robot in person, and other robots within the interaction environments.

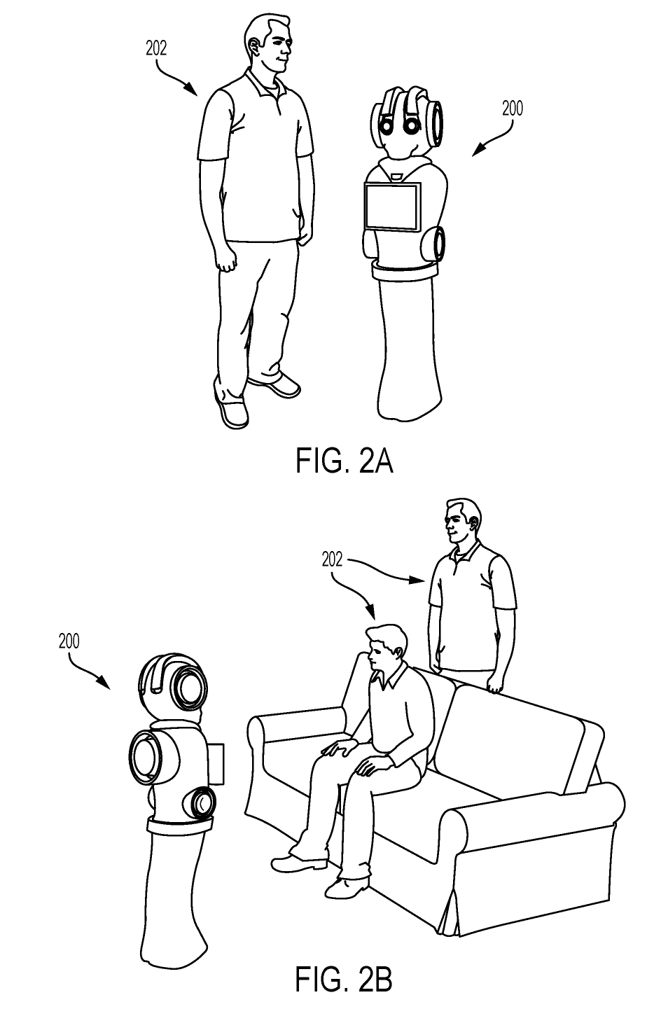

FIGS. 2A and 2B, without any limitation, are example environments of a MIP robot 200 configured interact with a user 202, wherein the user 202 is standing (FIG. 2A) and wherein the MIP robot 200 is situated in front of a user or other group of users 202 sitting (e.g., on a couch) and/or standing in the same or similar environment (FIG. 2B). The example MIP robot device 200 is the same that is detailed in MIP robot device 100 of FIG. 1. The robot device 200 can take input data from the user 202 using on-board sensors, camera, microphones in conjunction with facial and speech recognition algorithms processed by the onboard computer, direct input from the user 202 including, but not limited to, the example touch screen display, key-board, mouse, game controller, etc. The user or group of users 202 are configured to interact with the robot 200 within this example environment and can communicate with the MIP robot 200 using talking, typing of text on a keyboard, sending game controlling signals via the game controller, and expressing emotions including, but not limited to, direct talking, crying, laughing, singing and making jokes. In response to the input data received by the MIP robot 200, the robot 200 may choose to respond with a human like personality in a human like voices and recorded scenarios or a robot like personality in robot like voices and responses.

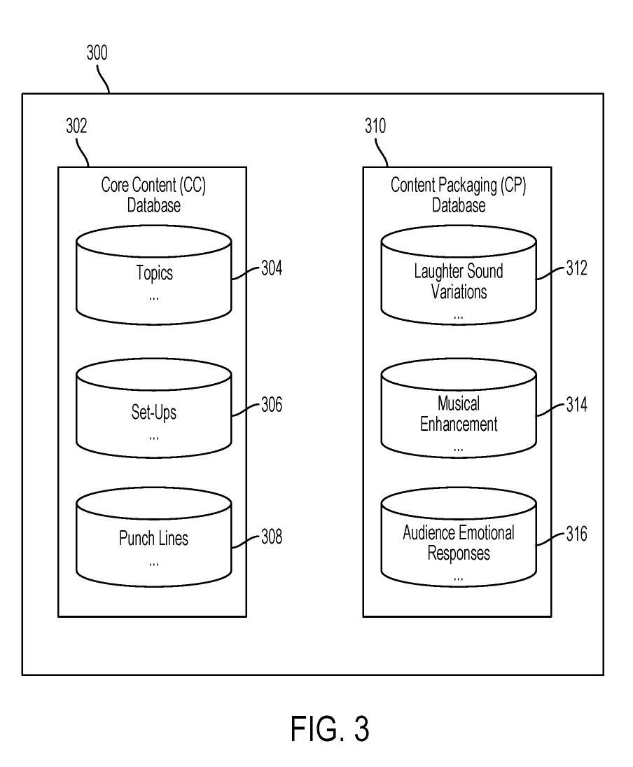

According to an aspect of the present disclosure, an example database of content 300 in FIG. 3, includes, without any limitation, data on lists of topics in database 304, lists of set-up comments related to each topic in database 306, lists of punch lines related to each topic and the set-up comments relevant or related to each topic in database 308. Based on the context of the robot-user interactions the robot or robot device, without any limitations, can choose a topic from database 304, choose and deliver one or more than one set-up comments related to the chosen and delivered topic from database 306, and choose and deliver one or more than one punch lines related to the chosen and delivered topic and the chosen and delivered set-up comments from database 308. According to one aspect, without any limitation, the databases 304, 306, and 308 together form a core content (CC) database 302 for a robot or a robotic device to choose a topic, choose and deliver set-up comments, and choose and deliver punch lines to form and deliver a joke, or a comedy monologue, or a comedy dialogue, or a comedy routine to a user dining continuing interaction between a robot or a robotic device and user or a group of users.

According to another aspect the example database 300 also includes a content packaging (CP) database 310. The content packaging CP database 310, without any limitation, includes audio- and video-recordings of laughter or people laughing of different intensity and durations in database 312, audio- and video-recordings of musical enhancements of different intensity and duration in database 314, and audio- and video-recordings of audience emotional responses of different intensity and duration in database 316. According to another aspect, the robot or a robotic device can choose and deliver an audio- and video-recording of laughter, choose and deliver an audio- and video-recording of musical enhancement, and choose and deliver audio- and video-recording of audience's emotional responses from the CP database 310 to package, without any limitation, a joke, or a comedy monologue, or a comedy dialogue, or a comedy routine, for delivery during a continuing interaction between a robot or a robotic device with a user or a group of users.

According to yet another aspect, example musical enhancements of database 314, without any limitation, may include audio- and video-of drum rolls, trumpets, bugle, songs, and human and animal voices in musical compositions and songs etc., and example audience emotional responses of database 316, without any limitation, may include audio and video recordings of laughter, cheering, applause, clapping, and sighs, etc.

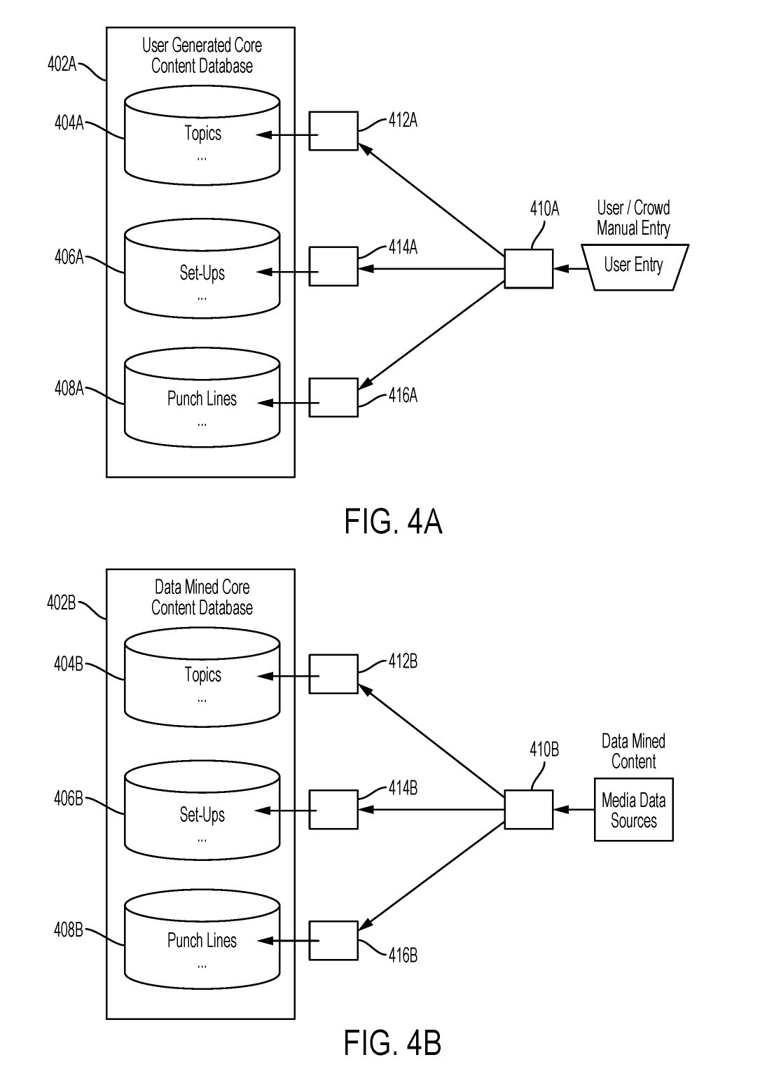

According to an aspect of the present disclosure, example methods to populate the CC database 302 of FIG. 3, is described in FIGS. 4A and 4B. Example sources for populating the CC database 302 can be of three types. According to a first aspect, as illustrated in FIG. 4A, an example method to source the data to populate the CC database 302, without any limitation, is user supplied or user generated content data 410A using web-, mobile-, robot-, or robotic-device interfaces. For example, the users could talk to a robot, or a robotic device face to face, or an AMIP chat- or chatter-bot remotely via web- or mobile-interfaces, to verbally supply or input (e.g., user/crowd data entry) the user supplied or user generated content data 410A comprising input data on topics 412A, input data on set-up comments 414A, and input data on punch lines 416A to populate databases 404A, 406A, and 408A of user generated core content (CC) database 402A. According to another aspect, as illustrated in FIG. 4B, without any limitation, data mining tools can be used on existing audio- and video-recordings of jokes, comedy monologues, comedy dialogues, and comedy (e.g., of media data sources) to extract data mined content data 410B comprising input data on topics 412B, input data on set-up comments related to the topics 414B, and input data on punch lines related to the topics and the set-up comments 416B. The extracted input data on topics 412B, set-up comments related to the topics 414B, and punch lines related to the topics and the set-up comments 416B are then used to populate databases 404B, 406B, and 400B of data-mined core content (CC) database 402B. In yet another aspect, without any limitation, topics, set-up comments, and punch lines from the user generated CC database 402A, can be combined with corresponding topics, set-up comments, and punch lines from the data-mined CC database 402B, to generate topics, set-up comments, and punch lines for new jokes, new comedy monologues, new comedy dialogues, and new comedy routines during a continuing interaction of a robot, or a robotic device, or an animated chat or chatter-bot with a user or a group of users.

According to one example, a User-1, interacting via a robot, a robotic device, or an AMIP chat- or chatter-bot via a web- or mobile-interface or application, with the system may enter or select a topic “Elephant” under a general category “Animals”. The User-1 may read and like the following Joke-1 harvested or data-mined from a digital listing or library to the data-mined CC database 402B:
Topic: Elephant
Joke-1, Set-up Comment-1: “Why are elephants so wrinkled?”
Joke-1, Punch Line-1: “Because they take too long to iron!!”

In such an example, Joke-1 from the data-mined CC database 402B, is provided to the User-1 via the topic “Elephant” chosen from database 404B, Set-up Comment-1 chosen from database 406B, and Punch-Line-1 chosen from database 408B.

Further in such an example, User-1 still interacting via the robot, the robotic device, or the AMIP chat- or chatter-bot via the web- or mobile-interface or application with the system, may decide to enter their own punch line to Joke-1, Set-up Comment-1. In such an aspect, the User-1 may enter the following user-supplied Joke-1, Punch Line-2 at 416A:
Joke-1, Punch Line-2: “So that there is room to grow!!”

Further in such an example, a User-2 interacting via another robot, robotic device, or AMIP chat- or chatter-bot via a web- or mobile-interface or application, also enters or selects the topic “Elephant” and reads the above Joke-1, Set-up Comment 1 and Joke-1, Punch Line-2 as part of a new/updated Joke-1 related/relevant to the topic of “Elephant”. Here, the User-2 may enter the following user-supplied Joke-1, Punch Line-3 at 416A:
Joke-1, Punch Line-3: “So that they look mature!!”

Further in such an example, a User-3 interacting via another robot, robotic device, or AMIP chat- or chatter-bot via a web- or mobile-interface or application, also enters or selects the topic “Elephant” and reads the above Joke-1, Set-up Comment 1 and Joke-1, Punch Line-2 as part of a new/updated Joke-1 related/relevant to topic of “Elephant”. Here, the User-3 may enter the following user-supplied Joke-2, Set-up Comment-1 at 414A:
Joke 2, Set-up Comment-1: “Can elephants grow bigger?”

Furthermore, the User-3 may also enter the following user-supplied Joke-2, Punch Line-1 at 416A:
Joke 2, Punch Line-1: “Yes, because they are so wrinkled!!”

In such an aspect, the Joke 2, Set-up Comment-1 is entered at 414A as related/relevant to the topic “Elephant” at 412A, and the Joke 2, Punch Line-1 is entered at 416A as related/relevant to the Joke 2, Set-up Comment-1 at 414A.

In the above-described example, the data-mined topic of “Elephant” chosen from database 404B, with Set-up Comment-1 chosen from database 406B and Punch line-1 chosen from database 408B, provide a Joke-1 from the data-mined CC database 402B to a user or a group of users. In the end: i) a new user-supplied Set-up Comment-1 is created at 414A and a Punch Line-1 related/relevant to the Set-up Comment-1 is created at 416A for a “new” 2^{nd} Joke (e.g. Joke 2) on the topic “Elephant” at 412A, and ii) a new user-supplied Punch Line-2 and Punch Line-3 are created at 416A for an “existing” 1^{st} Joke (e.g. Joke 1). Such user-supplied Set-up Comments (e.g., Set-up Comment-1) are entered into database 406A of the user-generated CC database 402A and such user-supplied Punch-Lines (e.g., Punch Line-2, Punch Line 3) are entered into database 408A of the user-generated CC database 402A.

Other users (e.g., other than User-1, User-2, User-3) may supply yet more Set-up Comments and yet more Punch Lines, in a similar manner, to create more updated/new Jokes under the topic of “Elephant” as part of a mixture of the topics, set-up comments and punch lines from the user-generated CC database 402A with the topics, set-up comments and punch lines from the data mined CC database 402B, without limitation.

For example, the user-generated CC database 402A and the data mined CC database 402B, updated in such a manner, could provide the following updated/new longer joke with three successive punch lines, in the following sequence, without any limitation:
Joke 1, Set-up Comment-1: “Why are elephants so wrinkled?”
Joke-1, Punch Line-1: “Because they take too long to iron!!”
Joke-1, Punch Line-2: “So that there is room to grow!!”
Joke 1, Punch Line-3: “So that they look mature!!”

According to various aspects of the present disclosure, as the number of user-supplied topics at 412A increase, one or more than one set-up comment for each topic at 414A, and one or more than one punch line for each set-up comment at 416A are populated in the user-generated CC database 402A. Updated/New jokes are created by the users themselves, or due to a mixing of topics, set-up comments, and punch lines from the user-generated CC database 402A with topics, set-up comments, and punch lines from the data mined CC database 402B.

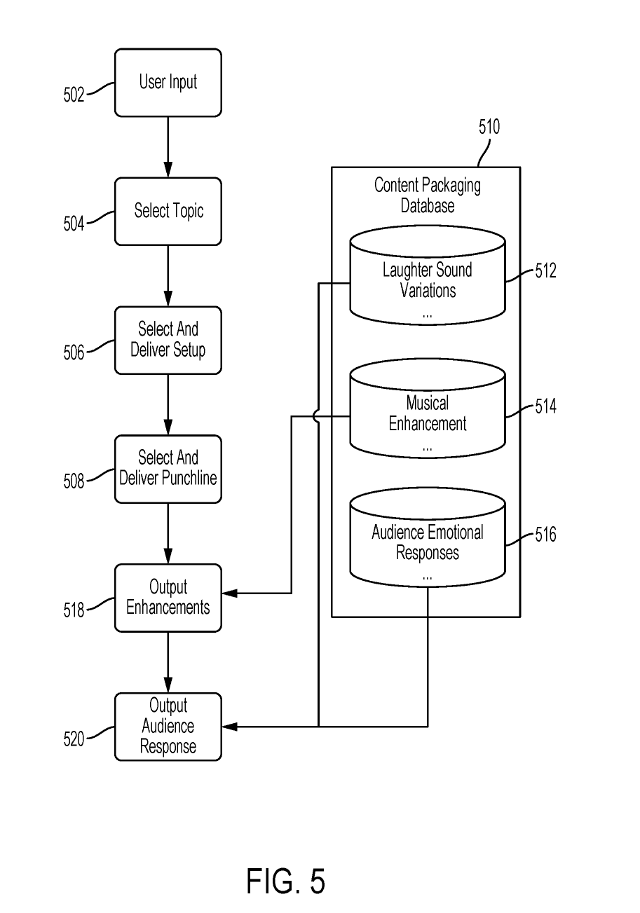

According to an aspect of the present disclosure, an example algorithm, without any limitation, for generating a joke, a comedy monologue, or a comedy dialogue, or a comedy routine during a continuing interaction between a robot and a user is described in FIG. 5. Based on a user's input in box 502 during a continuing interaction, a robot or a robotic device, without any limitation, determines the context of the interaction and selects a topic in box 504. Based on the topic selected, the robot or robotic device selects and delivers one or more than one set-up comments (e.g., from database 306 of the CC database 302 of FIG. 3) to the user in box 506 without any limitation. Based on the topic selected in box 504 and the set-up comments selected and delivered in box 506, the robotic device selects and delivers one or more than one punch lines (e.g., from database 308 of the CC database 302 of FIG. 3) to the user in box 508, without any limitation, to form and deliver the core content of an interactive joke, a comedy monologue, or a comedy dialogue, or a comedy routine to a user or a group of users during a continuing interaction.

In another aspect of the present disclosure, in view of FIG. 5, the robot or robotic device packages the thus formed and delivered interactive joke in audio and video clips of laughter selected from database 512, a musical enhancement selected from database 514, and people expressing emotions from database 516 (e.g., all of content packaging (CP) database 510) to deliver to a user or a group of users during a continuing interaction. The musical enhancement from database 514 is delivered at box 518 for the overall output enhancement of the delivered punch line. While as the audio- and video-clips of laughter from database 512 and emotions from database 516 are delivered at box 520 including overall audience personalities response available in a single- or multiple personality robot during a continuing interaction between the robot and user or a group of users. In another aspect of the present disclosure as described above, without any limitation, the packaging of the core content of a joke, or a comedy monologue, or a comedy dialogue, or a comedy routine means selecting and delivering the audio- and video clips of one or more than one laughter, one or more than one musical enhancement, and one or more than one emotion, in no particular order at boxes 518 and 520, after each punch line is selected and delivered during a continuing interaction between a robot or a robotic device interacting with a user or a group of users. In another aspect of the present disclosure, the audio and video clips of the musical enhancements could also be delivered before or after each set-up comments are selected and delivered, and before or after each punch lines are selected and delivered to build up the expectation and enhance the tempo of the joke during a comedy monologue, or a comedy dialogue, or a comedy routine during the continuing interactions between a robot or a robotic device and a user or a group of users. In yet another aspect of the present disclosure, the sound or audio clips can be delivered through the speaker while at the same time the visual or video clips can be delivered through the display screen available on a robot or a robotic device.

Continuing with the above example, the updated/new longer Joke-1 created through Set-up Comment-1 related/relevant to the topic “Elephant,” with Punch-Lines 1, 2 and 3 could be packaged with laughter sounds from database 512, musical enhancement from database 514 and audience response from database 516 and delivered by a robot, a robotic device, or an AMIP chat- or chatter-bot via a web- or mobile-interface or application to a user or a group of users. An example sequence, without limitation, of the packaged joke delivered to the user or the group of users selected at box 504 within the context of the topic “Elephant” or even “Animals” detected at box 502 (e.g., user input) is as follows:
Deliver aloud Joke 1, Set-up Comment-1: “Why are elephants so wrinkled?”;
Play music from database 514 to build up the suspense or expectation and enhance the tempo of the joke;
Deliver aloud Joke 1, Punch Line-1: “Because they take too long to iron!!”
Play a sound of laughter from database 512;
Deliver aloud Joke 1, Punch Line 2: “So that there is room to grow!!”
Play a louder sound of laughter from database 512 and some applause from database 516;
Deliver aloud Joke 1, Punch Line-3: “So that they look mature!!”
Play an even louder sound of laughter from database 512 and a loud sound of audience clapping from database 516.

In another aspect of the present disclosure, the packaging elements (e.g., from databases 512, 514, 516) selected for the core content elements (e.g., of boxes 506 and 508) of a joke, or a comedy monologue, or a comedy dialogue, or a comedy routine delivered at box 518 (e.g., musical enhancements) and box 520 (e.g., audience laughter and/or audience emotional responses) in no particular order, without any limitation, are a key part of the present disclosure for a single or a multiple personality interactive comedic robot or a robotic device, or their animated versions on web- or mobile interfaces during a continuing interaction with a user or a group of users face to face or remotely. This allows for clues to a user or a group of users as to when to anticipate the delivery of a set-up comment or a punch line, and when to even participate in the comedic routine being performed by laughing, cheering, applauding during a continuing interaction between a robot or a robotic device, or their animated versions on web and mobile interfaces during a continuing interaction with a user or a group of users face to face or remotely.

In another aspect of the present disclosure, the method/system allows for a user to record and upload audio-files, set-up comments, and/or punch lines in their own voice. In such an aspect, variation in jokes or new jokes is possible. For example, a joke may be delivered in one or more than one user's voice. In another example, a joke may be delivered in a mixture of more than one user's voice. In a crowd-sourcing environment/model, user feed-back may encourage or funnel good set-up comments and/or punch lines to the top of a ranked list for selection (e.g., delivered often, delivered in user preferred voices, etc.).

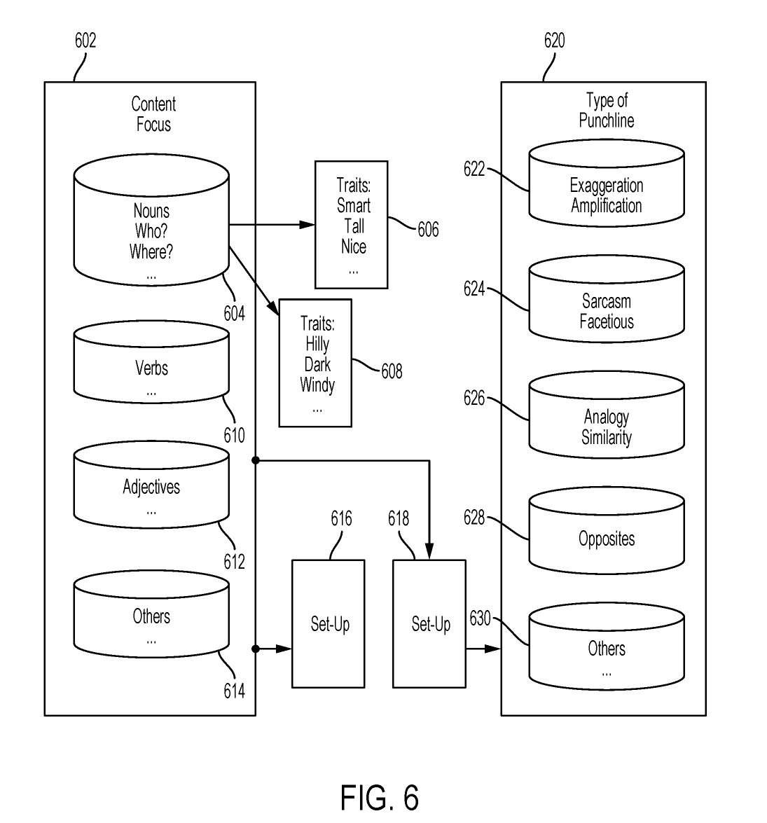

According to an aspect of the present disclosure, an example database and algorithm for focusing the context of the interactive joke, a comedy monologue, a comedy dialogue, or a comedy routine according to a user's trait, geolocation, time of the day, and mood, etc., and enhancing the punch lines with exaggeration, sarcasm, analogies, similarities, and opposites, etc., without any limitation, is described in FIG. 6. An example contextualization of a selected topic of a joke, a comedy monologue, a comedy dialogue, a comedy routine as according to a user's traits, without any limitation, are gathered from a data analysis of nouns in database 604, verbs in database 610, adjectives in database 612, and others in database 614 of content focus database 602. Example traits of a user or a group of users could be smart, tall, nice, and others at box 606, and example surroundings of a user or a group of users could be hilly, dark, windy, and others at box 608 without any limitation. According to an aspect, without any limitation, a user's traits could be focused at boxes 606 and 608 and could be used as criteria for the selection of relevant set-up comments at boxes 616 and 618 before the selection and delivery of punch lines for a single or multiple personality interactive comedic robot or a robotic device, or their animated versions on web- and mobile-interfaces during a continuing interaction with a user or a group or users face to face or remotely.

In another aspect of the present disclosure, example enhancements of the punch lines for enhancing the effect include amplification or exaggeration from database 622, sarcasm or facetious from database 624, analogies or similarities from database 626, opposites from database 628, and others from database 630 of type of punchline database 620. According to an aspect, set-up comments selected at box 618 could be used as criteria for the selection of appropriate enhancements for selected and delivered punch lines for a single or multiple personality interactive comedic robot or a robotic device, or their animated versions on web- and mobile-interfaces during a continuing interaction with a user or a group or users face to face or remotely.

In another aspect of the present disclosure, the contextualization of the set-up comments with elements as according to a user's traits (e.g., based on content focus database 602), and enhancing effects elements for the selection of punch lines as according to a user's preferences (e.g., based on type of punchline database 620), in no particular order, without any limitation, are also a key part of the present disclosure for a single or multiple personality interactive comedic robot or a robotic device, or their animated versions on web- or mobile interfaces during a continuing interaction with a user or a group of users face to face or remotely. This allows for the customization of a joke, a comedy monologue, a comedy dialogue, a comedy routine as according to a user's traits and preferences during a continuing interaction between a robot or a robotic device, or their animated versions on web and mobile interfaces interacting with a user or a group of users face to face or remotely.

Continuing the above example, the topic “Elephant” is listed and interpreted as: i) a noun in database 604, ii) a “wrinkled animal” in Set-up Comment-1 (e.g., “Why are elephants so wrinkled?”), iii) wherein wrinkled is an adjective in database 612 on an implicit noun “cloth” covering an elephant in Punch Line-1 (e.g., “Because they take too long to iron!!”) and Punch Line-2 (e.g., “So that there is room to grow”), and iv) wherein wrinkled is also interpreted as an adjective in database 612 on an implicit noun “skin” of an elephant in Punch Line-3 (e.g., “So that they look mature!!”). Such interpretations are utilized as criteria for the selection of related and/or relevant set-up comments at 616 and/or 618 to be delivered. Further, in such an example, set-up comments at box 618 are used as criteria for the selection of appropriate enhancements for selected and delivered punch lines. For example, Punch Lines 1-3, may be enhanced with amplification or exaggeration from database 622, sarcasm or facetious from database 624, analogies or similarities from database 626, opposites from database 628, and/or other enhancements from database 630 (e.g., misinterpretation or misdirection).

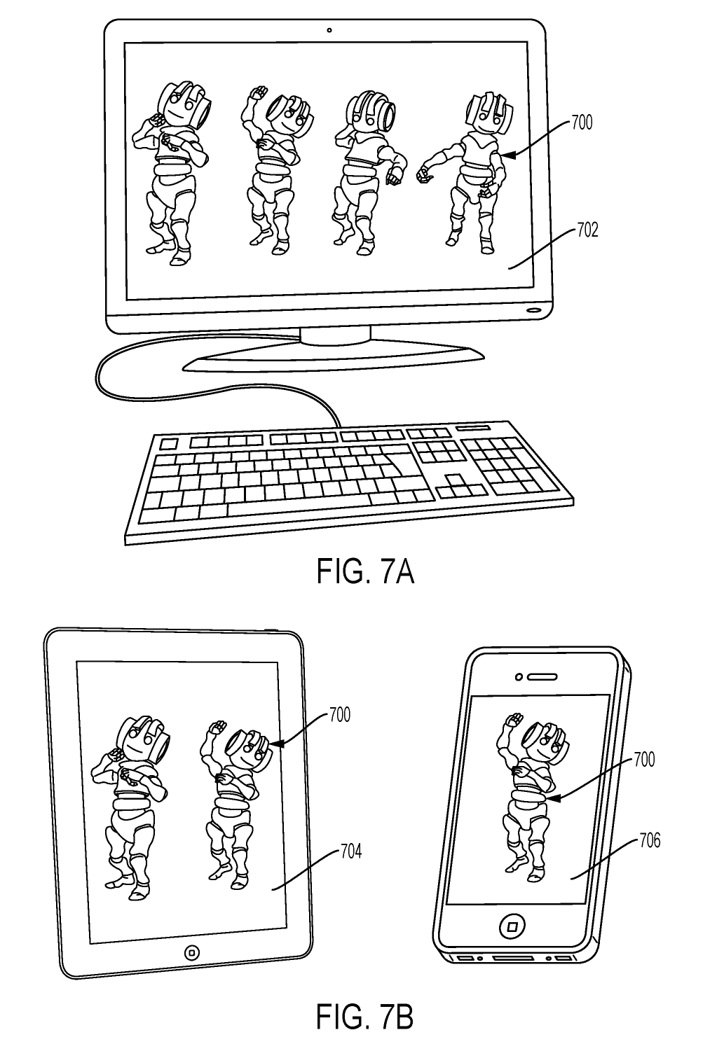

According to an aspect of the present disclosure, and disclosed in related International Patent Application No. PCT/US17/29385, purely software based animated versions of single or multiple interactive personality (MIP) robots of FIG. 1 are also created, which, without any limitations, are capable of interacting with a user via a web- or mobile-interface on internet connected web- or mobile devices, respectively. An animated version of the robot described in FIG. 1, capable of interacting with a user using a web- or mobile-interface is called an animated single or multiple interactive personality chatter- or chat-bot. An example sketch of an animated version of a MIP robot, capable of speaking with a user in multiple voices in human- and robot-like personalities is called an animated MIP (AMIP) chatter-bot. An example sketch of an AMIP chat- or chatter bot 700 on a web interface 702 is shown in FIG. 7A. An example sketch of an AMIP chat- or chatter-bot 700 on mobile tablet interface 704 or a smart-phone interfaces 706 is shown in FIG. 7B. The AMIP chat- and chatter-bots 700 are able to assess a user's mood and situation by asking direct questions, express emotions, tell jokes, make wise-cracking remarks, give applause, similar to a robot or robotic device for interactive comedy in a human-like manner during a continuing interaction or communication with a user or a group of users, while also responding in a robot-like AI manner during the same continuing interaction or communication with the same user or group of users.

According to another aspect, as disclosed in related International Patent Application No. PCT/US17/29385, the AMIP chat- or chatter-bots interacting with a remotely connected user or a group of users using web- or mobile-interfaces are used to collect user specified chat- and chatter input data including, but not limited to, user contact, gender, age-group, income group, education, geolocation, interests, likes and dislikes, as well as user's questions, comments, scripted scenarios and feed-back, etc., on the AMIP chat- and chatter-bot responses within a web- and mobile-based crowd sourcing environment.

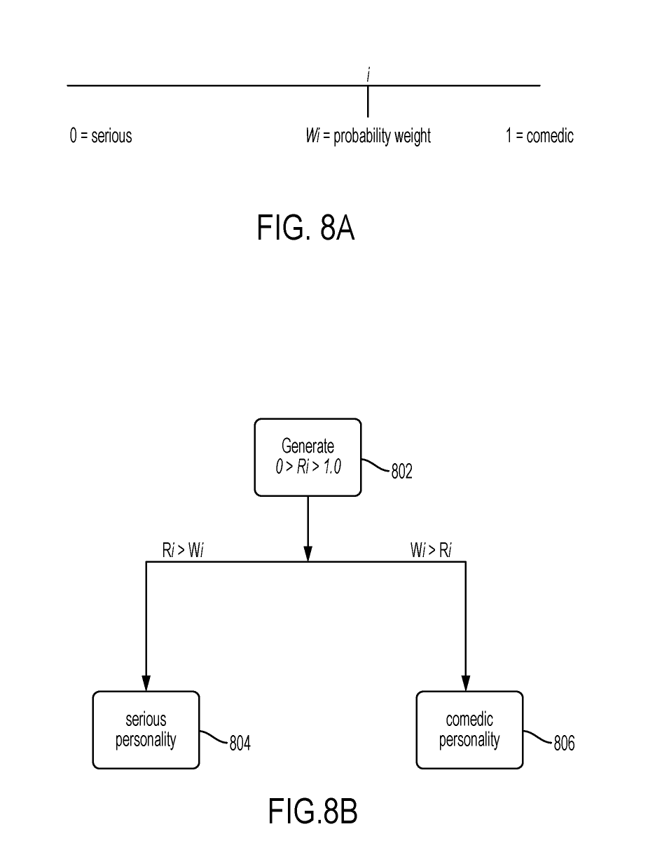

According to an aspect of the present disclosure, without any limitation, the ratio of “comedic” to “serious” personality traits within single- or multiple-personality robots or robotic devices, or their animated chat- and chatter-bot versions on the web- or mobile-interfaces can be varied and customized as according to a user or user group's preferences. This is done by including an additional probabilistic or stochastic component during a contextual focus of robot response as described in FIG. 6. An example algorithm to accomplish this, without any limitation, is described in FIGS. 8A and 8B. If there is a comedic response needed to a user's contextual input, an additionally probabilistic weight Wi for a user i with 0<Wi<1 is used to choose if the robot will respond with a “comedic” personality trait or a “serious” personality trait (FIG. 8A). In FIG. 8B, a random number 0<Ri<1 is generated, at box 802, and compared with Wi. For Wi>Ri, a single or multiple personality robot or a robotic device, or their animated chat- or chatter-bots versions on web- or mobile interfaces respond with “comedic” personality traits at box 806, otherwise a single or multiple personality robot or a robotic device, or their animated chat- or chatter-bot versions on web- or mobile interfaces respond with “serious” personality traits at box 804. The probabilistic weight factors Wi for a user or Wg for a group of users may be generated by an example steady state Monte Carlo type algorithm, without any limitation, during the customization of the robot using a crowd-sourcing user input and feedback approach as disclosed in related International Patent Application No. PCT/US17/29385.

According to another aspect of the present disclosure, without any limitation, similar probabilistic weight factors Wi for a user or Wg for a group of users are also correlated with user preferences for mixing comedic or serious personality traits with romantic, business type, fact based, philosophical, teacher type and other responses by single- or multiple-personality robots or robotic devices, or their animated chat- and chatter-bot versions on the web- or mobile-interfaces. Once enough “comedic” responses are populated within the robot response database, some users may prefer to mix “comedic” responses with romantic responses, while some other users may prefer to mix “comedic” responses with business like or fact based responses, while still some other users may prefer to mix “comedic” responses with philosophical, teacher type, or soulful responses. According to another aspect of the present disclosure, the example probability weight factors Wi closer to 1 may prefer mostly “comedic” responses, wherein the example probability weight factors Wi closer to 0 may prefer mostly “serious” responses (FIG. 8A). Example clustering and correlation type plots may segregate a group of users into sub-groups preferring to mix jovial or comedic personalities with emotional or romantic, business or fact based, philosophical, inspirational, religious or teacher type responses without any limitations.

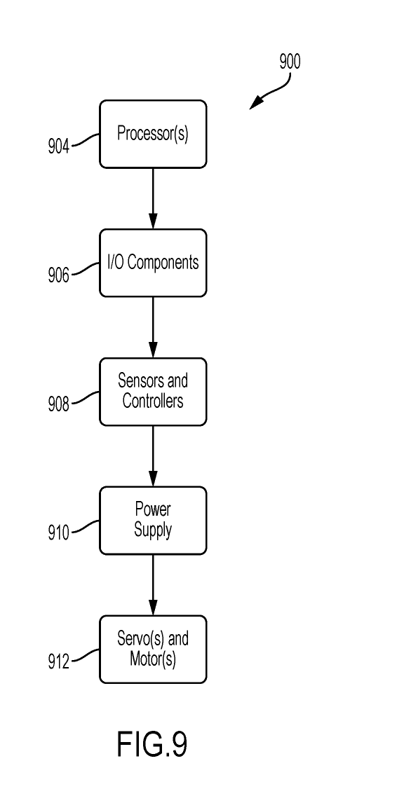

Having briefly described an example overview of the various aspects of the present disclosure, example operating environment, system, and components in which aspects of comedic single or multiple interactive personalities robots may be implemented are described below in order to provide a general robot context of various aspects of the present disclosure. It should be understood that the robot operating environment and the components in FIG. 9 and other arrangements described herein are set forth only as examples and are not intended to be of suggest any limitation as to the scope of the use and functionality of the present disclosure. The robot or robotic device 900 in FIG. 9 includes one or more than one bus that directly or indirectly couples memory/storage, one or more processors 904, sensors and controllers 908, input/output ports, input output components 906, an illustrative power supply 910, and servos and motors 912. These blocks represent logical, not necessarily actual, components. For example a display device could be an I/O components, processor could also have memory as according to the nature of art. FIG. 9 is an illustrative example of environment, computing, processing, storage, display, sensor, and controller devices that can be used with one or more aspects of the present disclosure.

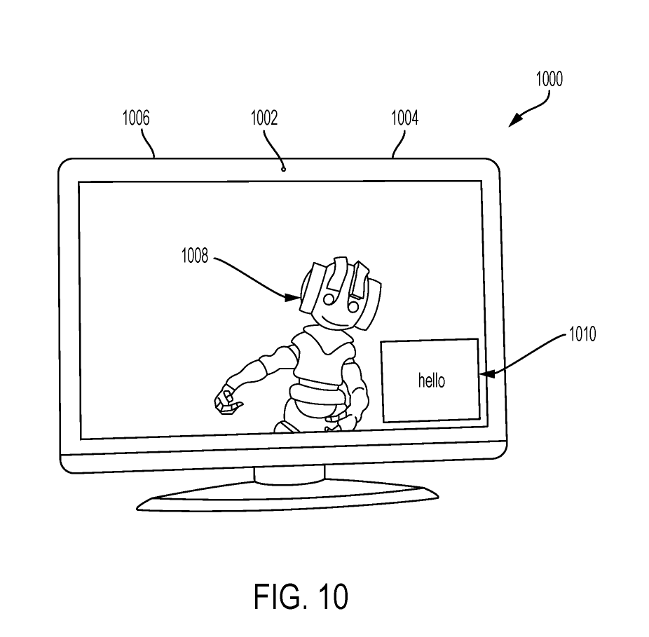

According to another aspect of the present disclosure, without any limitation, is an example interactive television system 1000 configured for interactive entertainment for a user or a group of users shown in FIG. 10. According to an aspect of the present disclosure, an example interactive television system or device 1000, includes an example mounted camera 1002 at the top, without any limitation, capable of scanning the area in front and receiving visual, image, or video input data from a user or group of users interacting with an interactive television system or device 1000. According to another aspect of the present disclosure, an example interactive television system or device 1000, also includes an example mounted microphone 1004 at the top, without any limitation, capable of scanning the area in front and receiving sound or audio input data from a user or group of users interacting with an interactive television system or device 1000. According to yet another aspect of the present disclosure, an example interactive television system or device 1000, also includes a projector 1006 to interact with a user or a group of users. According to yet another aspect of the present disclosure, without any limitation, the rest of the example logic, processing, memory/storage, input-output components, input-output ports, sensors, controllers, and power supply as implied in the example or illustrative components of FIGS. 1 and 9, except the capability to move, are also externally or internally integrated with the interactive television set or device 1000. According to yet another aspect of the present disclosure, the example interactive television set or device 1000, without any limitation, is capable of displaying an animated single or multiple interactive personality chatter-bot 1008, and/or an interactive serious robot-like AI based responsive personality 1010 (e.g., chat-bot) to generate and deliver jokes, comedy monologues, comedy dialogues, or comedy routines during a continuing interaction with a user or a group of users.

Another aspect of the present disclosure includes, without limitation, a package of a set-top one or more than one camera, a set-top one or more than one microphone, and a dongle containing software to convert a television (e.g., smart television) into an interactive smart television. Such a package may be supplied to convert a user's television into an interactive voice responsive (IVR) television set or device 1000, which remains stationary but is fully capable of delivering voice interactive audio-visual entertainment and AMIP personalities to a user or a group of users.

According to another aspect of the present disclosure, the placement and integration of the scanning camera 1002 for image and video inputs and micro-phone 1004 for sound or audio inputs and the rest of the components listed above are for illustrative purpose only, without any limitation, and could be configured in any other way for better performance, efficiency, and cost of the interactive television set or device 1000 configured to interact with a user or a group of users for comedic entertainment during a continuing interactions. According to yet another aspect of the present disclosure, a single or multiple interactive personality robot or robotic device could be situated near a regular television set to convert it into an interacting television set, via an HDMI or WIFI connective, to display animated single- or multiple interactive personality chat- and chatter-bots on the television display configured to deliver interactive jokes, comedy monologues, comedy dialogues, or comedy routines during a continuing interaction with a user or a group of users.

The components and tools used in the preset disclosure may be implemented on one or more computers executing software instructions. According to one aspect of the present disclosure, the tools used may communicate with server and client computer systems that transmit and receive data over a computer network or a fiber or copper-based telecommunications network. The steps of accessing, downloading, and manipulating the data, as well as other aspects of the present disclosure are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to aspects of the present disclosure.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other aspects, hardwired circuitry may be used in place of; or in combination with, software instructions to implement aspects of the present disclosure. Thus tools used in the present disclosure are not limited to any specific combination of hardware circuitry and software, nor to any particular source for the instructions executed by the server or client computers. In some instances, the client and server functionality may be implemented on a single computer platform.

Various aspects of the present disclosure are described in the following numbered clauses:

1. A method for generation, storage, and delivery of interactive jokes, comedy monologues, comedy dialogs, and comedy routines via robots or robotic systems or robotic devices, wherein the method comprises:

providing a robot with capability to create, store, delete, and update data into a database including one or more than one topic, one or more than one set-up comments relevant to each topic, and one or more than one punch lines relevant to each topic and to their each set-up comments, one or more than one audio- and video recordings of canned laughter of variable duration and intensity, one or more than one audio- and video recordings canned emotions of variable duration and intensity;

providing a robot with a capability to select a topic, without any limitation, stored within the robot based on a continuing interaction between a robot and a user or a group of users;

providing a robot with a capability to select and deliver a one or more than one set-up comments, without any limitation, relevant to a selected topic based on a continuing interaction between a robot and a user or a group of users;

providing a robot with a capability to select and deliver a one or more than one punch lines, without any limitation, relevant to a selected topic and the selected and delivered set-up comments based on a continuing interaction between a robot and a user or a group of users;

providing a robot with a capability to select and deliver audio- and video-recordings of canned laughter and canned emotions before or after each punch line is selected and delivered during a continuing interaction between a robot and a user or group of users; and

providing a robot with a capability to generate, store, update, query and deliver interactive jokes, comedy monologues, comedy dialogues, and comedy routines focused on a user's specific traits, mood, geo-location, environment, and preferences during a continuing interaction between a robot and a user or a group of users.

2. The method of clause 1, wherein a user or a group of users submit their input data relevant to jokes, comedy monologues, comedy dialogues, and comedy routines, as topics, set-up comments related to topics, and punch lines related to topics through web- or mobile interfaces, without any limitation, for populating the database to be used by a robot with capability to generate, store, update, and query data into a database including topics, set-up comments relevant to each topic, and punch lines relevant to topics and their set-up comments.
3. The method of clause 1, including a data-mining algorithm, without any limitation, used on existing data comprised of audio- and video recordings of comedians performing jokes, comedy monologues, comedy dialogues, and comedy routines in radio or television sitcoms to harvest input-data on topics, set-up comments related to topics, and punch lines related to topics and their setup comments, without any limitation, for populating the database to be used by a robot with capability to generate, store, update, query data into a database including topics, set-up comments relevant to each topic, and punch lines relevant to topics and their set-up comments.
4. The method of clause 1, including a mixing algorithm, without any limitation, used for generation, storage, update, selection, query and delivery of new jokes, new comedy monologues, new comedy dialogues, and new comedy routines based on mixing of user supplied data of the method of clause 2 with the data-mining algorithm supplied data of the method of clause 3.
5. The method of clause 1, wherein a robot, or a robotic system or device, without any limitation, includes an algorithm to select a topic, select and deliver one or more than one set-up comments, select and deliver one or more than one punch lines following the selection and delivery of one or more than one set-up comments, select and deliver audio- and video-recordings of canned laughter, select and deliver audio- and video recordings of canned emotions following the delivery of each punch line during a continuing interaction between a robot and a user or a group of users.
6. The method of clause 1, wherein a robot, or a robotic device, without any limitation, speaks in a single voice with a single robot like personality with suitable facial expressions corresponding to robot's personality, to generate, store, update, query and deliver jokes, comedy monologues, comedy dialogues, and comedy routines, accompanied with audio- or video-recordings of canned laughter, and accompanied with audio- or video recordings of canned emotions, during a continuing interaction between a robot and a user or a group of users.
7. The method of clause 1, wherein a multiple interactive personality (MIP) robot or a MIP robotic system or device, covered in related International Patent Application No. PCT/US17/29385, without any limitation, speaks in one or more than one “human-like” or “robot-like” voices accompanied with suitable facial expressions corresponding to robot's multiple interactive personalities, to generate, store, update, query and deliver jokes, comedy monologues, comedy dialogues, and comedy routines, accompanied with audio- and video-recordings of canned laughter, and accompanied with audio- and video recordings of canned emotions, during a continuing interaction between a robot and a user or a group of users.
8. The method of clause 1, wherein a single- or a MIP-robot, a robotic system or device uses audio- or video-recordings or animation footage to express canned emotions, wherein canned emotions, without any limitations, include love, empathy, encouragement, happiness, sadness, anger, cheering, and applause of various types and intensity, delivered on a display screen, or on a device, or via a mechanism to display facial expressions, or via a mechanism to express body movements during a continuing interaction between a robot and a user or a group of users
9. The method of clause 1, wherein a single- or a MIP robot or a single or MIP robotic device, covered in related International Patent Application No. PCT/US17/29385, without any limitation, has a capability to generate, store, update, query and deliver interactive jokes, comedy monologues, comedy dialogues, and comedy routines focused on a user's specific traits, mood, geo-location, environment, and user preferences during a continuing interaction between a robot and a user or a group of users.
10. The method of clause 1, wherein traits may include, without any limitation, built, color, ethnicity, looks, geo-location, preferences, mood, environment, time of the day, occasions, events during a continuing interaction between a robot and a user or a group of users.
11. The method of clause 1, wherein the languages to generate, store, update, query, and deliver jokes, comedy-monologues, comedy-dialogues, and comedy routines during a continuing interaction between a robot and a user or a group of users, without any limitation, include one, more than one, or any combination of the major spoken languages including English, French, Spanish, Russian, German, Portuguese, Chinese-Mandarin, Chinese-Cantonese, Korean, Japanese and major South Asian and Indian languages such as Hindi, Urdu, Punjabi, Bengali, Gujrati, Marathi, Tamil, Telugu, Malayalam, and Konkani, and major African sub-continental and Middle Eastern languages.
12. The method of clause 1, wherein the accents, without any limitation, include localized speaking style or dialect of any one or combination of the major spoken languages of clause 11.
13. The method of clause 1, wherein the emotions of the spoken words or speech, without any limitation, include variations in tone, pitch, and volume to represent emotions commonly associated with human and digitally recorded human voices.
14. The method of clause 1, wherein the suitable facial expressions to accompany a joke or a comedy monologue, a comedy dialogue, a comedy routine in a robot are generated by variation in the shape of eyes, color changes in eyes using miniature LED lights, and shape of the eyelids as well the six degrees of motion of head in relation to the torso.
15. The method of clause 1, wherein the suitable facial expressions to accompany a joke, or a comedy monologue, or a comedy dialogue, or a comedy routine in a robot are generated by variation in the shape of the mouth and lips using miniature LED lights.
16. The method of clause 1, wherein a joke, or a comedy monologue, or a comedy dialogue, or a comedy routine with suitable facial expressions in a robotic device, without any limitation, are accompanied with head and hand movements or gestures of the robot.
17. The method of clause 1, wherein multiple personality types with suitable facial expressions in a robot are accompanied with a motion of the robot within an interaction range or communication range, without any limitation, of a user or a group of users configured to interact with each other and with the robot.
18. The method of clause 1, wherein the robot is capable of computing on-board and is configured to interact within an ambient environment without a user or group of users present within the environment.
19. The method of clause 1, wherein the robot is configured to interact with another robot of the method of clause 1 within an ambient environment without any user or a group of users present within the environment.
20. The method of clause 1, wherein the robot is configured to interact with another robot of the method of clause 1 within an ambient environment with a user or a group of users present in the environment.
21. The method of clause 1, wherein the connection device may include, without any limitation, a key-board, a touch screen, an HDMI cable, a personal computer, a mobile smart phone, a tablet computer, a telephone line, a wireless mobile, an Ethernet cable, or a Wi-Fi connection.
22. The method of clause 1, wherein a joke, or a comedy monologue, or a comedy dialogue, or a comedy routine of a robot, without any limitation, are based on the context of the local geographical location, local weather, local time of the day, and the recorded historical information of a user or group of user configured to interact with a robot.
23. The method of clause 1, wherein the robot may still perform functionally useful tasks as performed by any other robot for a user or a group of users, while during the same continuing interaction, the user or the group of users are also entertained by jokes, comedy monologue, comedy dialogue, and comedy routines performed by the robot.
24. The method of clause 1, wherein the robot may perform jokes, a comedy monologue, a comedy dialogue, or a comedy routine, express happy or sad emotions, sing songs, play music, tells stories, make encouraging remarks, make spiritual or inspirational remarks, make wise-cracking remarks, and do typical robotic functional tasks, without any limitation, for the companionship and entertainment of a user or a group of users configured to interact with the robot.
25. The method of clause 1, wherein the robot is used for a user or a group of users for companionship, entertainment, storytelling, education, teaching, training, greeting, guiding, guest service, customer service and any other purpose, without any limitation, while also performing functionally useful robotic tasks.
26. The method of clause 1, where the human like and robot like multiple interactive personalities of clauses 6 and 7 are implemented as a software versions in animated comedic single- and comedic animated multiple interactive personality (AMIP) chat- and chatter-bots designed and configured to interact with a user or a group of users through web-, or mobile, or projector-, or television, or augmented reality (AR) and virtual reality (VR) displays or interfaces and devices supporting them.
27. The method of clause 1, wherein AMIP chat- and chatter-bots use jokes, comedy-monologues, comedy-dialogues, and comedy routines to interact with a user or a group of users during a continuing interaction through web-, or mobile, or projector-, or television, or augmented reality (AR) and virtual reality (VR) displays or interfaces and devices supporting them.
28. The method of clauses 26 and 27, wherein the software version of AMIP chat and chatter-bots use jokes, comedy-monologues, comedy-dialogues, and comedy routines to interact or communicate with remotely located user or group of users to collect data from users including, but not limited to, user contact, gender, age-group, income group, education, geolocation, interests, likes and dislikes, as well as user's questions, comments, and input on jokes and comedy scenarios and feed-back etc., within a web-, mobile-, television-, AR-, or VR-based face to face or remotely connected crowd sourcing environment.
29. The method of clause 28, wherein user generated data on jokes, comedy monologues, dialogues, and comedy routines collected from remotely connected users interacting with AMIP chat- and chatter-bots through web-, mobile-, television-, AR-, or VR-based face to face or remotely connected crowd sourcing environment, without any limitation, is used for creating default comedic multiple interactive personalities, and customization of the comedic multiple interactive personalities as according to user's preferences via interactive feedback loops. The customized personalities as according to user's preferences are then available for download in robots made using the method of clause 1.
30. The method of clause 29, wherein the ratio of humor based and non-humor based responses delivered to users via web-, mobile-, television-, AR-, or VR-based face to face or remotely connected crowd sourcing environment are adjusted using an algorithm, without any limitation, using a feedback loop to customized the AMIP chat- and chatter-bots according to user's preferences. The customized personalities as according to user's preferences are then available for download and use as multiple interactive personalities robots made using the method of clause 1.
31. A robotic apparatus system, capable of exhibiting one, two, or more than two personality types of clauses 1 and 6-8, comprising:

a physical robot apparatus system;

a central processing unit (cpu);

sensors that collect input data from users within the interaction range of the robot; controllers to control the head, facial, eyes, eyelids, lips, mouth, and base movements of the robot;

wired or wireless capability to connect with internet, mobile, cloud computing system, other robots with ports to connect with key-board, USB, HDMI cable, a television, personal computer, mobile smart phone, tablet computer, telephone line, wireless mobile, Ethernet cable, and Wi-Fi connection;

an infrared universal remote output to control external television, projector, audio, video,

AR-VR-equipment, devices and appliances;

a touch sensitive or non-touch sensitive display connected to keyboard, mouse, game controllers via suitable ports;

a PCI slot for single or multiple carrier SIM card to connect with direct wireless mobile data line for data and VOIP communication;

an onboard battery or power system with wired and inductive charging stations;

memory including the stored previous data related to the personalities of the robot as well as the instructions to be executed by the processor to process the collected input data for the robot to perform the following functions without any limitations:
obtain information from the sensor input data;
determine which one of the multiple personality types will respond determine the manner and type of the response;
execute the response by the robot without any overlap or conflict between multiple personalities;
store the information related to changing the multiple personalities of the robot change any one or all stored multiple personalities of the robot;
delete a stored previous personality of the robot; and
create a new personality of the robot.
   32. The robotic system of clause 31, wherein the input data, with in the vicinity or the interaction range including the robot and a user or a group of users, comprises:

one or more communicated characters, words, and sentences relating to written and spoken communication between a user and the robot;

one or more communicated images, lights, videos relating to visual and optical communication between a user and the robot;

one or more communicated sound or audio related to the communication between a user and the robot;

one or more communicated touch related to the communication between a user and the robot to communicate the information related to determining the previous mood of the user or a group of users as according to clause 1.

33. An interactive television system configured for interactive entertainment including, without any limitation, an internally or externally connected robotic system of clause 31, without any limitation, capable of using AMIP chat- and chatter-bots of the methods of clauses 27 and
28 on the full television display to perform interactive comedic jokes, comedic monologues, comedic dialogues, and comedic routines during a continuing interactive communication between an interactive television and a user or a group of users.
34. The interactive television system of clause 33, without any limitation, wherein the AMIP chat- and chatter-bots on a part of the television display may perform jokes, a comedy monologue, a comedy dialogue, or a comedy routine, express happy or sad emotions, sing songs, play music, make encouraging remarks, make spiritual or inspirational remarks, make wise-cracking remarks, while the interactive television may show usual programming on the remaining part of the display, without any limitation, for the entertainment of a user or a group of users configured to interact with the interactive television.
35. The interactive television system of clause 33, wherein AMIP chat- and chatter-bots on a television display are able to speak in synthesized voice of human and animal characters and actors, made to animate the resemblance of human and animal characters and actors playing parts in an interactive animated movie or video for the interactive entertainment of a user or a group of users, wherein the characters of the interactive movie or video are also able to communicate during a continuing interaction with a user or group of users.
36. The interactive television system of clauses 33-35 configured for interactive entertainment by AMIP chatter and chat-bots used for a user or a group of users for companionship, entertainment, education, storytelling, video-game playing, teaching, training, greeting, guiding, guest service, customer service and any other purpose, without any limitation, while also performing functionally useful non-moving robotic tasks while the robot may remain completely stationary within the interactive television system.
37. A computer readable medium with stored executable instructions in the robotic system of clauses 31 and 33 that when executed by a computer apparatus, cause the computer apparatus to perform the methods of clauses 1-30 to receive input data, process the data to provide information to the robot apparatus to choose one of the two or more than two interactive personalities for a robot, robotic system, robotic device, animated chat-bot, animated chatter-bots to respond and communicate with a user or a group of users.

The present disclosure is not limited to the various aspects described herein and the constituent elements can be modified in various manners without departing from the spirit and scope of the disclosure. Various aspects of the disclosure can also be extracted from any appropriate combination of a plurality of constituent elements disclosed herein. Some constituent elements may be deleted from all of the constituent elements disclosed in the various aspects. The constituent elements described in different aspects of the present disclosure may be combined arbitrarily.

Various aspects of the present disclosure are described more fully hereinafter with reference to the accompanying drawings, which form a part hereof, and which show, by way of illustration, specific example aspects by which the disclosure may be practiced. Various aspects may, however, be embodied in many different forms and should not be construed as limited to the aspects set forth herein. Rather, the disclosed aspects are provided so that this disclosure will be thorough and complete, and will fully convey the scope of the disclosure to those skilled in the art.

Throughout the specification and claims, the following terms take the meanings explicitly associated herein, unless the context clearly dictates otherwise. The phrase “in one aspect” as used herein does not necessarily refer to the same aspect, though it may. Furthermore, the phrase “in another aspect” as used herein does not necessarily refer to a different aspect, although it may. Thus, as described below, various aspects of the disclosure may be readily combined, without departing from the scope or spirit of the disclosure.

Still further, while certain aspects of the disclosure have been described, these aspects have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method for generation, storage, and delivery of interactive jokes, comedy monologues, comedy dialogs, and comedy routines via robots or robotic systems or robotic devices, wherein the method comprises:
providing a robot with a capability to create, store, delete, and update data in a database including one or more than one topic, one or more than one set-up comment relevant to each topic, one or more than one punch line relevant to each topic and to each set-up comment, one or more than one audio- and video recording of canned laughter of variable duration and intensity, and one or more than one audio- and video recording of canned emotions of variable duration and intensity;
providing the robot with a capability to select a topic stored within the database based on a continuing interaction between the robot and a user or a group of users;
providing the robot with a capability to select and deliver one or more than one set-up comment relevant to the selected topic based on the continuing interaction between the robot and the user or the group of users;
providing the robot with a capability to select and deliver one or more than one punch line relevant to the selected topic and the one or more than one selected and delivered set-up comment based on the continuing interaction between the robot and the user or the group of users;
providing the robot with a capability to select and deliver one or more than one audio- and video-recording of canned laughter and one or more than one audio- and video recording of canned emotions before or after each punch line is selected and delivered during the continuing interaction between the robot and the user or the group of users; and
providing the robot with a capability to generate, store, update, query and deliver interactive jokes, comedy monologues, comedy dialogues, and comedy routines focused on specific traits, mood, geo-location, environment, and preferences of the user or the group of users during the continuing interaction between the robot and the user or the group of users.

2. The method of claim 1, further comprising:
submitting by the user or the group of users, via web- or mobile interfaces, input data relevant to the interactive jokes, the comedy monologues, the comedy dialogues, and the comedy routines, as topics, set-up comments related to the topics, and punch lines related to the topics and the set-up comments, to populate the database to be used by the robot with the capability to generate, store, update, and query the data in the database including topics, set-up comments relevant to each topic, and punch lines relevant to each topic and to each set-up comment.

3. The method of claim 1, further comprising:
using a data-mining algorithm on existing data comprising audio- and video recordings of comedians performing jokes, comedy monologues, comedy dialogues, and comedy routines in radio or television sitcoms to harvest input data on topics, set-up comments related to the topics, and punch lines related to the topics and the set-up comments, to populate the database to be used by the robot with the capability to generate, store, update, and query data in the database including topics, set-up comments relevant to each topic, and punch lines relevant to each topic and to each set-up comment.

4. The method of claim 1, further comprising:
submitting by the user or the group of users, via web- or mobile interfaces, input data relevant to the interactive jokes, the comedy monologues, the comedy dialogues, and the comedy routines, as topics, set-up comments related to the topics, and punch lines related to the topics and the set-up comments;
using a data-mining algorithm on existing data comprising audio- and video recordings of comedians performing jokes, comedy monologues, comedy dialogues, and comedy routines in radio or television sitcoms to harvest input data on topics, set-up comments related to the topics, and punch lines related to the topics and the set-up comments; and
using a mixing algorithm for the generation, storage, update, selection, query and delivery of new interactive jokes, new comedy monologues, new comedy dialogues, and new comedy routines based on a mixing of the input data submitted by the user or the group of users with the input data harvested via the data-mining algorithm.

5. The method of claim 1, wherein the robot comprises an algorithm to:
select the topic;
select and deliver the one or more than one set-up comment;
select and deliver the one or more than one punch line following the selection and the delivery of the one or more than one set-up comment; and
select and deliver the one or more than one audio- and video-recording of canned laughter and the one or more than one audio- and video recording of canned emotions following the selection and the delivery of each punch line during the continuing interaction between the robot and the user or the group of users.

6. The method of claim 1, further comprising:
providing the robot with a capability to speak in a single voice with a single robot-like personality with facial expressions corresponding to the robot-like personality during the continuing interaction between the robot and the user or the group of users.

7. The method of claim 1, wherein the robot comprises a multiple interactive personality (MIP) robot, and wherein the method further comprises:
providing the MIP robot with a capability to speak in one or more than one human-like or robot-like voice with facial expressions corresponding to the multiple interactive personalities during the continuing interaction between the robot and the user or the group of users.

8. The method of claim 1, wherein the robot comprises a single personality robot or a multiple interactive personality (MIP) robot, and wherein the method further comprises:
delivering audio- or video-recordings or animation footage, via a display screen, a device, a mechanism to display facial expressions, or a mechanism to express body movements, to express the canned emotions during the continuing interaction between the robot and the user or the group of users, wherein the canned emotions comprise love, empathy, encouragement, happiness, sadness, anger, cheering, and applause of various types and intensity.

9. The method of claim 1, wherein the robot comprises a single personality robot or a multiple interactive personality (MIP) robot.

10. The method of claim 1, wherein the traits of the user or the group of users comprise build, color, ethnicity, and looks, and wherein the method further comprises:
providing the robot with a capability to generate, store, update, query and deliver interactive jokes, comedy monologues, comedy dialogues, and comedy routines focused on specific occasions, a time of the day, and events during the continuing interaction between the robot and the user or the group of users.

11. The method of claim 1, further comprising:
providing the robot with a capability to generate, store, update, query, and deliver interactive jokes, comedy monologues, comedy dialogues, and comedy routines in a language comprising one or more than one of:
a major spoken language including English, French, Spanish, Russian, German, Portuguese, Chinese-Mandarin, Chinese-Cantonese, Korean, and Japanese;
a major spoken South Asian and Indian language including Hindi, Urdu, Punjabi, Bengali, Gujrati, Marathi, Tamil, Telugu, Malayalam, and Konkani; and
a major spoken African sub-continental and Middle Eastern language, during the continuing interaction between the robot and the user or the group of users.

12. The method of claim 11, wherein the one or more than one language comprises an accent including a localized speaking style or a dialect.

13. The method of claim 1, further comprising:
providing the robot with a capability to speak words or speech comprising variations in tone, pitch, and volume to represent emotions associated with a human and digitally recorded human voices.

14. The method of claim 1, further comprising:
providing the robot with a capability to generate facial expressions to accompany an interactive joke, a comedy monologue, a comedy dialogue, or a comedy routine, wherein the facial expressions are generated by varying a shape of the eyes of the robot, changing a color of the eyes of the robot using miniature LED lights, changing a shape of the eyelids of the robot, and moving a head of the robot in relation to a torso of the robot via at least six degrees of motion.

15. The method of claim 1, further comprising:
providing the robot with a capability to generate facial expressions to accompany an interactive joke, a comedy monologue, a comedy dialogue, or a comedy routine, wherein the facial expressions are generated by varying a shape of the mouth and lips of the robot using miniature LED lights.

16. The method of claim 1, further comprising:
providing the robot with a capability to generate facial expressions with head and hand movements or gestures to accompany an interactive joke, a comedy monologue, a comedy dialogue, or a comedy routine.

17. The method of claim 1, wherein the robot comprises a multiple interactive personality (MIP) robot with multiple personality types, and wherein the method further comprises:
providing the MIP robot with a capability to generate facial expressions for the multiple personality types accompanied with a motion of the robot within an interaction range or a communication range of the user or the group of users interacting with each other and with the MIP robot.

18. The method of claim 1, further comprising:
providing the robot with a capability to compute on-board; and
providing the robot with a capability to interact within an ambient environment without the user or the group of users present within the ambient environment.

19. The method of claim 1, further comprising:
configuring the robot to interact with another robot within an ambient environment without the user or the group of users present within the ambient environment.

20. The method of claim 1, further comprising:
configuring the robot to interact with another robot within an ambient environment with the user or the group of users present in the ambient environment.

21. The method of claim 1, wherein the interaction between the robot and the user or the group of users is via a connection device comprising a key-board, a touch screen, an HDMI cable, a personal computer, a mobile smart phone, a tablet computer, a telephone line, a wireless mobile, an Ethernet cable, or a Wi-Fi connection.

22. The method of claim 1, further comprising:
providing the robot with a capability to generate, store, update, query and deliver an interactive joke, a comedy monologue, a comedy dialogue, or a comedy routine based on a context of the local geographical location, local weather, a local time of the day, and recorded historical information of the user or the group of users interacting with the robot.

23. The method of claim 1, further comprising:
providing the robot with a capability to perform robotic functional tasks for the user or the group of users while the robot entertains the user or the group of users with the interactive jokes, the comedy monologues, the comedy dialogues, and the comedy routines.

24. The method of claim 1, further comprising:
providing the robot with a capability to perform jokes, a comedy monologue, a comedy dialogue, or a comedy routine, express happy or sad emotions, sing songs, play music, tell stories, make encouraging remarks, make spiritual or inspirational remarks, make wise-cracking remarks, and perform robotic functional tasks for the companionship and entertainment of the user or the group of users interacting with the robot.

25. The method of claim 1, further comprising:
providing the robot with a capability to perform robotic functional tasks for the user or the group of users; and
using, by the user or the group of users, the robot for companionship, entertainment, storytelling, education, teaching, training, greeting, guiding, guest service, or customer service.

26. The method of claim 1, wherein the robot comprises an animated single personality robot with a single robot-like personality or an animated multiple interactive personality (AMIP) robot with multiple interactive personalities comprising one or more than one robot-like personality and one or more than one human-like personality, and wherein the method further comprises:
providing, via software, the single robot-like personality as a comedic animated single personality chat- or chatter bot or the multiple interactive personalities as a comedic AMIP chat- or chatter bot; and
interacting with the user or the group of users, via a web-, or a mobile-, or a projector-, or a television, or a augmented reality (AR), or a virtual reality (VR) display or interface, by the comedic animated single personality chat- or chatter bot or the comedic AMIP chat- or chatter bot.

27. The method of claim 1, wherein the robot comprises an animated multiple interactive personality (AMIP) chat- or chatter bot, and wherein the method further comprises
providing, via software, the AMIP chat- or chatter bot; and
interacting with the user or the group of users, via a web-, or a mobile-, or a projector-, or a television, or a augmented reality (AR), or a virtual reality (VR) display or interface, by the AMIP chat- or chatter bot using interactive jokes, comedy monologues, comedy dialogues, or comedy routines.

28. The method of claim 27, wherein the user or the group of users is remotely located, and wherein the method further comprising:
interacting with the user or the group of users, via the web-, or the mobile-, or the television, or the AR, or the VR based face to face or remotely connected crowd sourcing environment, by the AMIP chat- or chatter bot software, using interactive jokes, comedy monologues, comedy dialogues, or comedy routines to collect data from the user or the group of users, wherein the data includes user contact, gender, age-group, income group, education, geolocation, interests, likes and dislikes, as well as user questions, comments, and input on jokes, comedy scenarios and feed-back.

29. The method of claim 28, further comprising:
creating default comedic multiple interactive personalities from user generated data on the interactive jokes, the comedy monologues, the comedy dialogues, or the comedy routines collected from the remotely located user or group of users;
customizing, via interactive feedback loops, the default comedic multiple interactive personalities according to preferences of the user or the group of users; and
making customized comedic multiple interactive personalities available for download to robots.

30. The method of claim 29, further comprising:
adjusting, using an algorithm, a ratio of humor based and non-humor based responses delivered to the user or the group of users via the web-, or the mobile-, or the television, or the AR, or the VR based face to face or remotely connected crowd sourcing environment using the feedback loop used to customize the AMIP chat- or chatter-bot of the user or the group of users.

31. A robotic system capable of exhibiting at least one personality type, the robotic system comprising:
a physical robot;
a central processing unit;
a database configured to store one or more than one topic, one or more than one set-up comment relevant to each topic, one or more than one punch line relevant to each topic and to each set-up comment, one or more than one audio- and video recording of canned laughter of variable duration and intensity, and one or more than one audio- and video recording of canned emotions of variable duration and intensity,
a sensor configured to collect input data from a user or a group of users within an interaction range of the robot;
a controller configured to control head, face, eye, eyelid, lip, mouth, and base movements of the robot;
a network connection configured to connect with an internet, a mobile, or a cloud computing system, a robot with ports to connect via a USB or a HDMI cable, a television, a personal computer, a mobile smart phone, a tablet computer, a telephone line, wireless mobile, an Ethernet cable, or a Wi-Fi connection, wherein the network connection comprises a wired or a wireless connection;
an infrared universal remote output configured to control an external television, projector, audio, video, an augmented reality device, or a virtual reality device;
a touch sensitive or a non-touch sensitive display connected to at least one of a keyboard, a mouse, or game controllers via ports;
a PCI slot for a single or a multiple carrier SIM card to connect with a direct wireless mobile data line for data and VOIP communication;
an onboard battery or power system comprising wired and inductive charging stations;
a memory storing instructions executable by the central processing unit to:
obtain, from the sensor, input data collected from the user or the group of users;
determine one or more than one personality type of the at least one personality type to respond to the user or the group of users;
determine a manner and a type of responses for the user or the group of users, the determination comprising:
selecting a topic stored within the database based on the input data collected from the user or the group of users;
selecting one or more than one set-up comment relevant to the selected topic;
selecting one or more than one punch line relevant to the selected topic and the selected one or more than one set-up comment; and
selecting one or more than one audio- and video-recording of canned laughter and one or more than one audio- and video recording of canned emotions;
execute the determined responses without any overlap or conflict between the one or more than one personality type, the execution comprising:
delivering the selected one or more than one set-up comment;
delivering the selected one or more than one punch line;
delivering the selected one or more than one audio- and video-recording of canned laughter and one or more than one audio- and video recording of canned emotions before or after the delivered one or more than one punch line; and
delivering interactive jokes, comedy monologues, comedy dialogues, and comedy routines focused on specific traits, mood, geo-location, environment, and preferences of the user or the group of users; and
manage the at least one personality type, the managing comprising:
storing data related to previous personality types;
storing information related to changing the one or more than one personality type;
change any one of the at least one personality type;
delete a previous personality type; and
create a new personality type.

32. A robotic system of claim 31, wherein the input data, within the vicinity or the interaction range including the robot and the user or the group of users, comprises:
one or more communicated characters, words, or sentences relating to a written or spoken communication between the user or the group of users and the robot;
one or more communicated images, lights, or videos relating to visual or optical communication between the user or the group of users and the robot;
one or more communicated sound or audio related to the communication between the user or the group of users and the robot; and
one or more communicated touch related to the communication between the user or the group of users and the robot;
wherein the input data is utilized in the determination of the manner and the type of responses for the user or the group of users.

33. An interactive television system configured for interactive entertainment, the interactive television system comprising:
a television display interface; and
a robotic system internally or externally connected to the television display interface, wherein the robotic system comprises software configured to:
provide an animated multiple interactive personality (AMIP) chat- or chatter-bot on the television display interface; and
interact, via the AMIP chat- or chatter-bot, with a user or a group of users by performing interactive comedic jokes, comedic monologues, comedic dialogues, and comedic routines during a continuing interactive communication between the interactive television system and the user or the group of users.

34. The interactive television system of claim 33, wherein the software is further configured to provide the AMIP chat- or chatter-bot on a part of the television display interface, and wherein the software is further configured to interact with the user or the group of users by performing jokes, a comedy monologue, a comedy dialogue, or a comedy routine, expressing happy or sad emotions, singing songs, playing music, making encouraging remarks, making spiritual or inspirational remarks, or making wise-cracking remarks, for the entertainment of the user or the group of users, while the interactive television system is configured to show usual programming on the remaining part of the television display interface.

35. The interactive television system of claim 33, wherein the software is further configured to provide the AMIP chat- or chatter-bot that:
speaks in a synthesized voice of a human character, an animal character, or an actor; and
animates a resemblance to human characters, animal characters, or actors playing parts in an interactive animated movie or video;
wherein the human characters, the animal characters, or the actors of the interactive animated movie or video are able to communicate during a continuing interaction with the user or the group of users.

36. The interactive television system of claim 33, wherein the software is further configured to provide the AMIP chat- or chatter-bot that:
performs non-moving robotic functional tasks for the user or the group of users, as the robotic system is connected to the television display interface, while the AMIP chat- or chatter-bot provides interactive entertainment for the user or the group of users for companionship, entertainment, education, storytelling, video-game playing, teaching, training, greeting, guiding, guest service, or customer service.

37. A computer readable medium with executable instructions stored thereon, the instructions when executed by a processor of a robotic system cause the robotic system to:
create, store, delete, and update data in a database including one or more than one topic, one or more than one set-up comment relevant to each topic, one or more than one punch line relevant to each topic and to each set-up comment, one or more than one audio- and video recording of canned laughter of variable duration and intensity, and one or more than one audio- and video recording of canned emotions of variable duration and intensity,
collect input data from a user or a group of users during a continuing interaction between the robotic system and the user or the group of users;
determine one or more than one personality type of the at least one personality type to respond to the user or the group of users;
select a topic stored within the database based on the input data collected from the user or the group of users;
select and deliver one or more than one set-up comment relevant to the selected topic based on the continuing interaction between the robot and the user or the group of users;
select and deliver one or more than one punch line relevant to the selected topic and the one or more than one selected and delivered set-up comment based on the continuing interaction between the robot and the user or the group of users;
select and deliver one or more than one audio- and video-recording of canned laughter and one or more than one audio- and video recording of canned emotions before or after each punch line is selected and delivered during the continuing interaction between the robot and the user or the group of users; and
generate, store, update, query and deliver interactive jokes, comedy monologues, comedy dialogues, and comedy routines focused on specific traits, mood, geo-location, environment, and preferences of the user or the group of users during the continuing interaction between the robot and the user or the group of users.
